(19) United States
(12) Patent Application Publication
(10) Pub. No.: US 2007/0136286 A1
(43) Pub. Date: Jun. 14, 2007

(54) Sortable Collection Browser

(75) Inventors: Steven David Webster, Scotland Island (AU); Jonathan Anthony Duhig, Scotland Island (AU); Laurence Crew, Redfern (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/556,088

(22) Filed: Nov. 2, 2006

(30) Foreign Application Priority Data
Nov. 30, 2005 (AU) 2005239672

(51) Int. Cl. G06F 7/00

(52) U.S. Cl. 707/7

(57) ABSTRACT

Disclosed is a method of browsing a collection of sortable items (201) stored in a digital system. A plurality of grouping hierarchies (207, 217) are provided, each comprising a sort order and zero or more grouping levels (204-206, 214-216) forming groups with which the items are associable. At least one grouping hierarchy comprises a sort order and at least one grouping level. One item (203) in the collection is set to be a focus item (208, 218) thereby establishing a current focus group (209, 219) of a current grouping hierarchy. The focus item is then maintained upon selection of a new grouping hierarchy (210-220) from one of the plurality. A displaying of the collection of items may be performed by arranging the items in a list sorted according to one sort order of a plurality of sort orders associable with the items. The plurality of grouping hierarchies may then be used, each grouping hierarchy corresponding to one of the sort orders, wherein each level of each grouping hierarchy is associable with at least one level of each other grouping hierarchy. At least part of the collection is the displayed based upon the one sort order of items represented and the corresponding one grouping hierarchy.

### CROSS-REFERENCE TO RELATED PATENT APPLICATION

This application claims the right of priority under 35 U.S.C. § 119 based on Australian Patent Application No. 2005239672 filed 30 Nov. 2005, which is incorporated by reference herein in its entirety as if fully set forth herein.

### FIELD OF THE INVENTION

The present invention relates to browsing information and, in particular, to displaying and manipulating a sortable collection of items stored in a digital system.

### BACKGROUND

With the proliferation of the electronic storage of items such as documents, songs, images and video sequences as data files on personal computers and other digital media storage devices, there is an increasing need for ways to manage this content for the purpose of finding, sharing and viewing the items.

There are a number of common solutions to this problem including organising the items into hierarchical structures for ‘browsing’, and also using keywords or expressions for ‘searching’. For many users the task of organising their files into effective hierarchies for later retrieval, and the ability to remember filing locations proves to be difficult, increasingly so over time and given large numbers of files. Constructing search queries can be similarly challenging and is often ineffective when searching for non-text based data items such as songs or images.

For a device with limited input capabilities such as a hand held media device or a device connected to a television display and controlled via a remote control, the problem of browsing or searching a large collection is exacerbated. Typically such devices lack a keyboard for typing search queries and a fine control pointing device like a mouse, and often have screens that are small (in the case of hand held devices) or relatively low resolution (in the case of television displays). Therefore, searching and browsing techniques which work reasonably well on a personal computer are problematic for these devices.

Metadata is well known concept. Whilst items stored as files in digital form generally include data arranged in a given format, such as an ASCII data for text documents or binary data for songs or images, additional data that identifies, describes or otherwise relates to the item but does not form part of the data that is intrinsic to the item is referred to as metadata. Common examples of metadata are file names, files sizes, folder locations, modification dates, keywords and descriptive text. Metadata may be stored directly alongside the item data in a file system, within a separate file in a file system or in a database, for example.

A common approach to using metadata to aid the browsing of items is to allow the user to select a value or a range of values for a particular metadata category or ‘dimension’ and applying a filter on the collection of items so that the scope of items to be browsed is narrowed. In the case of limited input devices the metadata dimensions and filter values can be presented as a cascading menu structure, allowing the application and removal of metadata based filters to be carried out with a limited range of user interactions such as up, down, left, right and select. An example of such a device is the iPod™ music player manufactured by Apple Computer, Inc. A limitation of this style of metadata based browsing is that when browsing items based on one metadata dimension, the user must return to a ‘top level’ before selecting another metadata dimension and therefore begin searching from scratch, losing all context of where the user had previously browsed.

Some browsing applications have the ability to group individual items. For example, Windows™ Explorer™, manufactured by Microsoft Corp. of U.S.A, has for some time had the ability to arrange icons according to metadata such as ‘name’, ‘size’, ‘type’ and ‘modified’. In the more recent ‘XP Professional’ incarnation, Windows™ Explorer™ has the additional capability to ‘Show in Groups’. In a first example, where the user has arranged icons according to ‘name’, the items are listed alphabetically. When shown in groups, the same list is broken into groups each defined by a letter of the alphabet. In a second example, icons may be arranged by size, in which file folders are listed initially, followed by individual files ordered according to size and starting at 0 KB. When shown in groups, in order of display the groups are ‘zero’ (ie. 0 KB), ‘tiny’ (eg. 1 KB-39 KB), ‘small’ (eg. 40 KB-129 KB), ‘medium’ (eg. 130-1299 KB), ‘large’ (>1300 KB), and then “folders”. However, when shown in groups, the items within each group are not presented with any reliable ordering. In the first example, file folders with each group appear to be listed first in alpha order, followed by files in alpha order. In the second example, folders are handle separately, but within each group, files are listed in alpha order, not size order. Similarly if ‘modified’ is selected, items within groups are arranged in alpha order.

Another type of browsing application that often groups items is email applications such as Outlook Express™ (Microsoft Corp.) and Thunderbird™ (Mozilla Corp.). In these applications, regardless of the selected grouping, items (ie. individual emails) appear to be always sorted according to date, as such clearly of most importance in communications systems.

It would be desirable to provide for metadata based browsing which maintains the context of browsing operations.

### SUMMARY OF THE INVENTION

In accordance with one aspect of the present disclosure there is provided a method of browsing a collection of sortable items stored in a digital system, said method comprising the steps of:

providing a plurality of grouping hierarchies, each said grouping hierarchy comprising a sort order and zero or more grouping levels forming groups with which said items are associable, wherein at least one said grouping hierarchy comprises a sort order and at least one grouping level;

setting one item in the collection to be a focus item thereby establishing a current focus group of a current grouping hierarchy; and

maintaining the focus item upon selection of a new grouping hierarchy from one of the plurality.

In accordance with another aspect of the present disclosure there is provided a method of displaying a collection of items stored in a digital system, said method comprising the steps of:

(a) arranging the items in a list sorted according to one sort order of a plurality of sort orders associable with the items;

(b) providing a plurality of grouping hierarchies, each said grouping hierarchy corresponding to one of the sort orders, wherein each level of each said grouping hierarchy is associable with at least one level of each other said grouping hierarchy; and

(c) displaying at least part of the collection based upon the one sort order of items represented and the corresponding one grouping hierarchy.

In accordance with another aspect of the present disclosure there is provided a graphical menu for display via a computerised display comprising a vertically arranged ring and a horizontally arranged ring, where:

each of the rings comprises a plurality of selectable menu items,

one menu item in each said ring is selected at any one time,

the selected menu items are visually dominant in the respective rings, and

the horizontal ring is represented in a plane that is offset from a centre axis of the vertical ring such that the selected menu item of the vertical ring is not obscured by the horizontal ring.

In accordance with another aspect of the present disclosure there is provided a method of traversing a hierarchical representation of data, said representation comprising a plurality of data items arranged as a sorted list and a plurality of data attributes associable with each of said items, said representation having intermediate nodes corresponding to said attributes and leaf nodes corresponding to said items, each of the intermediate nodes being associable with a grouping level in the hierarchy, said method comprising the step of:

traversing directly from one said node at one level to another adjacent node at said one level.

In accordance with another aspect of the present disclosure there is provided a displayable user interface for browsing a collection of data items, said interface comprising:

a first display area in which a list associated with said items is displayable;

a second display area for displaying at least attributes of a focus one said data items;

at least one third display area for displaying selectable sort orders related to said attributes of said data items and groupings related to said sort orders; and

a user operable selection arrangement by which one of the sort orders or the groups is selectable to alter at least a representation of said list in said first display area.

Other aspects are also disclosed.

### BRIEF DESCRIPTION OF THE DRAWINGS

At least one embodiment of the present invention will now be described with reference to the drawings in which:

FIG. 1 is a system diagram showing a typical digital system for the reproduction of data items;

FIG. 2A is a schematic diagram representing a collection of items and a grouping hierarchy;

FIG. 2B is a schematic diagram representing a collection of items and a plurality of grouping hierarchies;

FIG. 3 is an exemplary table of grouping hierarchies for browsing a collection of photos;

FIGS. 4A-4D illustrate an example user interface of an image browser according to the present disclosure;

FIG. 5 illustrates a graphical menu for choosing grouping hierarchies and grouping levels;

FIG. 6 illustrates a control device;

FIG. 7 is an exemplary table of grouping hierarchies for browsing a collection of songs;

FIGS. 8A-8E illustrate an example of a user interface of a music browser according to the present disclosure FIGS. 9A-9C illustrate an alternate user interface of a music browser;

FIGS. 10A-10C show an alternate user interface for a music browser and a change to a new focus item;

FIG. 11 is a schematic block diagram representation of a general purpose computer upon which the described arrangements may be implemented; and

FIG. 12 shows an alternate interface for a photographic collection;

FIG. 13 shows the interface of FIG. 12 with an alternate grouping;

FIG. 14 schematically shows a further displayable interface;

FIGS. 15A to 15D are flowcharts of a method of browsing a sortable collection of data items; and

FIG. 16 is a hierarchical tree representation of a collection of data items.

### DETAILED DESCRIPTION INCLUDING BEST MODE

Disclosed is a method for browsing a collection of items stored in a digital system. Items may include images, songs, movies, documents or data records. The actual storage of such collections of items in digital systems is well known. Items are typically stored in a hierarchical file system or a database structure on a storage medium such as a hard disk, optical disk or random access memory (RAM).

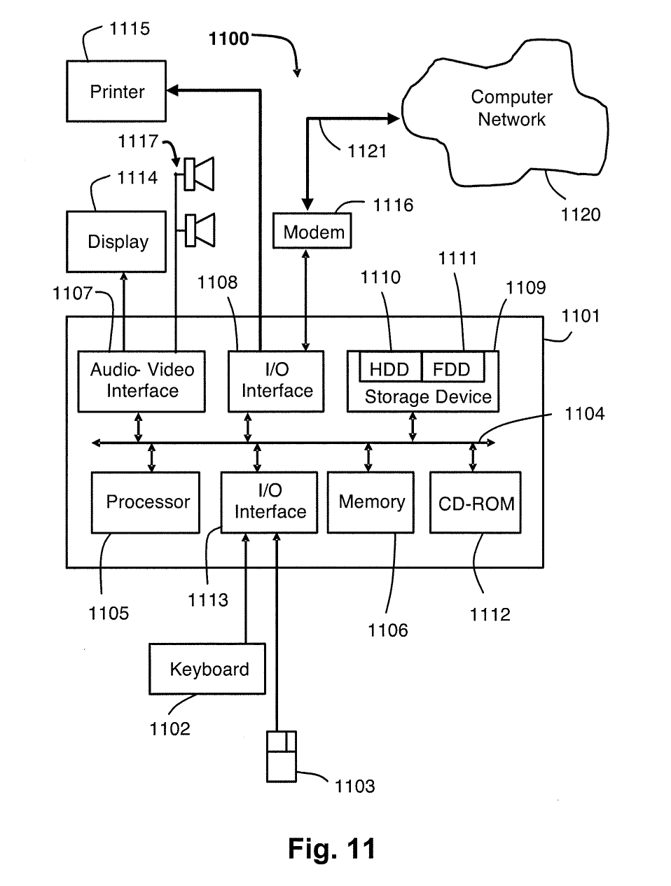

The methods of browsing a collection of data files or items to be described may be practiced using a general-purpose computer system 1100, such as that shown in FIG. 11 wherein the processes to be described with reference to the remaining figures may be implemented as software, such as an application program executing within the computer system 1100. In particular, the steps of the browsing methods are effected by instructions in the software that are carried out by the computer. The instructions may be formed as one or more code modules, each for performing one or more particular tasks. The software may also be divided into two separate parts, in which a first part performs the actual browsing and searching methods, and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for browsing a collection of data items.

The computer system 100 is formed by a computer module 1101, input devices such as a keyboard 1102 and mouse 1103, output devices including a printer 1115, a display device 1114 and loudspeakers 1117. A Modulator-Demodulator (Modem) transceiver device 1116 is used by the computer module 1101 for communicating to and from a communications network 1120, for example connectable via a telephone line 1121 or other functional medium. The modem 1116 can be used to obtain access to the Internet, and other network systems, such as a Local Area Network (LAN) or a Wide Area Network (WAN), and may be incorporated into the computer module 1101 in some implementations.

The computer module 1101 typically includes at least one processor unit 1105, and a memory unit 106, for example formed from semiconductor random access memory (RAM) and read only memory (ROM). The module 1101 also includes an number of input/output (I/O) interfaces including an audio-video interface 1107 that couples to the video display 1114 and loudspeakers 1117, an I/O interface 1113 for the keyboard 1102 and mouse 1103 and optionally a joystick or other interface control (not illustrated), and an interface 1108 for the modem 1116 and printer 1115. In some implementations, the modem 1116 may be incorporated within the computer module 1101, for example within the interface 1108. A storage device 1109 is provided and typically includes a hard disk drive 1110 and a floppy disk drive 1111. Other interfaces, such as Universal Serial Bus (USB) connections may also be included to permit connection to other devices, including portable data storage or reproduction systems. A magnetic tape drive (not illustrated) may also be used. A CD-ROM drive 1112 is typically provided as a non-volatile source of data. The components 1105 to 1113 of the computer module 1101, typically communicate via an interconnected bus 1104 and in a manner which results in a conventional mode of operation of the computer system 1100 known to those in the relevant art. Examples of computers on which the described arrangements can be practised include IBM-PC's and compatibles, Sun Sparcstations or alike computer systems evolved therefrom.

Typically, the application program is resident on the hard disk drive 1110 and read and controlled in its execution by the processor 1105. Intermediate storage of the program and any data fetched from the network 1120 may be accomplished using the semiconductor memory 1106, possibly in concert with the hard disk drive 1110. In some instances, the application program may be supplied to the user encoded on a CD-ROM or floppy disk and read via the corresponding drive 1112 or 1111, or alternatively may be read by the user from the network 1120 via the modem device 1116. Still further, the software can also be loaded into the computer system 1100 from other computer readable media. The term “computer readable medium” as used herein refers to any storage or transmission medium that participates in providing instructions and/or data to the computer system 1100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1101. Examples of transmission media include radio or infra-red transmission channels as well as a network connection to another computer or networked device, and the Internet or Intranets including e-mail transmissions and information recorded on Websites and the like.

Whilst the computer system 1100 may be used to implement the browsing arrangements to be described, such may also be configured in more specific user devices of smaller size or limited application. Such include, but are not limited to, portable/personal audio and/or video reproduction devices, for example utilizing MP3 or MPEG file formats.

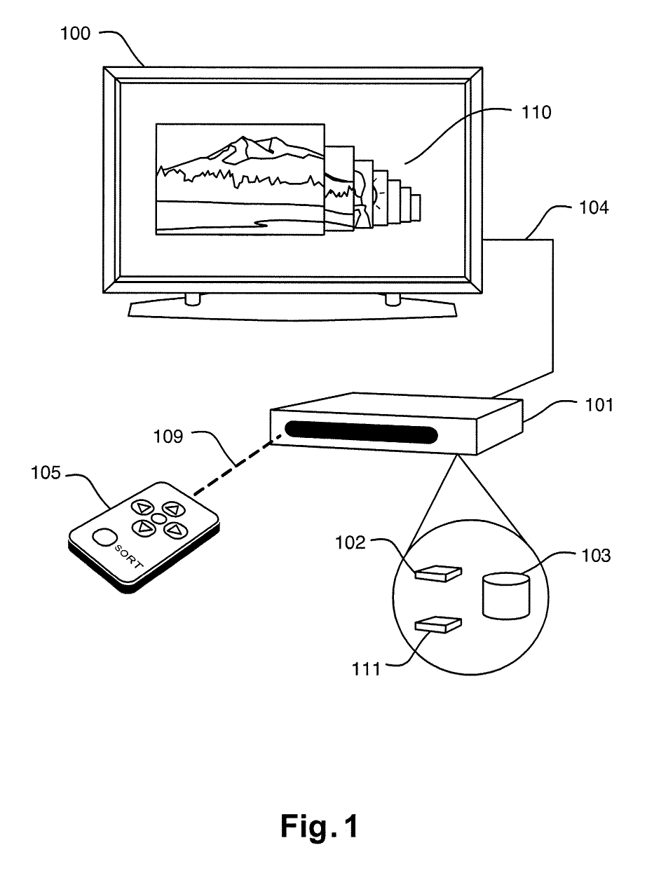

FIG. 1 shows a digital system having a display 100 connected to a media device 101 by a connector 104. The media device 101 comprises at least a Central Processing Unit (CPU) 102 and a data storage system 103, typically configured in a manner akin to corresponding components of the computer 1101 of FIG. 11 described above. The media device 101 may be a dedicated reproduction device, a device with additional capabilities such as a TV tuner, a set-top box, or a DVD player, or may be a general purpose Personal Computer (PC). The media device 101 may additionally contain a Graphics Processing Unit (GPU) 111 which assists in the rendering of the user interface to the display 100. The GPU 111 may support the execution of graphics libraries such as OpenGL. The data storage system 103 typically contains a plurality of items represented in digital form generally stored in the storage system 103. Alternatively, in network configured arrangements, such as a CATV set-top box arrangement, the device 101 may provide access via the network to the stored items.

An application program operating in accordance with the present disclosure and executed by the CPU 102, optionally assisted by the GPU 111, causes a user interface 110 to be rendered upon the display 100.

A control device 105 is operable by a user to transmits a signal 109 to the media device 101, wherein the signal is received by the CPU 102 and causes control events to occur which may result in changes to the state of the digital system and to the user interface 110. The signal 109 may be an infra-red signal or alternatively the control device 105 may also be connected by one or more wires or may be integrated into the media device 101. The control device 105 may be a standard input device such as a keyboard or mouse.

In some implementations, the Central Processing Unit (CPU) 102, optional Graphics Processing Unit (GPU) 111 and data storage system 103 may be contained directly within the chassis of the display 100, thereby eliminating the need for the media device 101 and connector 104. In other implementation, the display 100 may be portable. Further, the functional components of the device 101 may be included in a device with additional capabilities, for example a digital camera, with the user interface 110 being rendered either on a display which is integrated into the device or on an external display. Some components and user controls may be shared between the browsing application and any additional capabilities of the device.

In the browsing application program, items of a collection are organised as a sorted stack or list. The sorting of the list is performed by the application program executing upon the device 101 and is generally performed upon an attribute of the metadata. The sorting of the list can be interpreted to result in a linear list of set of data permitting the list to be traversed from one item to another whilst following the sort order. The sort is most desirably unique, and such may require sub-sorts upon other attributes of items in the collection. At any time, exactly one item in the collection is considered or identified to be ‘in focus’. This item may also be the item currently selected by the user. This item is herein referred to as the ‘focus item’. Navigating the collection entails scrolling or otherwise traversing through the sorted stack or list of items, wherein the focus item changes as the stack or list is scrolled.

Preferably, the stack or list can be scrolled, browsed or traversed continuously, returning to the first item in the list after reaching the last item, and vice versa, in a circular fashion. For example, scrolling forwards from Z continues to A in an alphabetic list (when there are no non-alphabetic characters or numerals in the list), and scrolling back from A continues to Z. An indication may be provided to the user of the system when such boundary points are reached.

Given any collection of items, there are potentially a number of different aspects that can be used as a basis for sorting the collection. These include aspects intrinsic to the item data, for example the dominant colour in an image or the length of a song; metadata associated with the item such as a name or classification, or an arbitrary order determined by the designer or user of the system. The application of particular aspects to the sorting of a collection of items is herein referred to as a ‘sort order’. As such, sort order(s) are associable with the items of the collection.

At any time whilst navigating the collection, according to preferred implementations, the collection of items can be re-sorted according to any one of a set of sort orders, and the focus item will be maintained before and after the collection is re-sorted. In order to support this aspect, it is appreciated that every sort order should include every item in the collection being browsed, and therefore filtering of the collection is undesirable. Filtering however may be used to limit the collection size or to exclude from the sort those items that do not possess a metadata attribute upon which the sort can be performed.

Given any aspect of a collection of items that can be used as the basis for a sort order, it is generally possible to group the items according to that aspect. For example, given alphabetic metadata such as a file name, it is possible to group the items according to those items whose file name begins with ‘A’, then those whose file name begins with ‘B’, then ‘C’ and so forth. Additionally it is generally possible to define a grouping scheme that has more than one level of grouping, based on a single aspect. From the previous example, it would further be possible to group the items according to those whose file name begins with the letters ‘A’ through to ‘K’, and those whose file name begins with the letters ‘L’ through to ‘Z’. In this example the groups ‘A’, ‘B’, ‘C’ etc would be referred to as ‘first level groups’ with the collection of first level groups being referred to as a ‘first grouping level’, whilst groups ‘A-K’ and ‘L-Z’ would be referred to as ‘second level groups’ with the collection of second level groups being referred to as a ‘second grouping level’.

In addition to containing all of the individual items whose file name begins with the letters ‘A’ through to ‘K’, such a group could also be said to contain the group of items whose file name begins with ‘A’, the group of items whose file name begins with ‘B’ and so forth up to the ‘K’ group. As such the groups and items can be seen to follow the pattern of a hierarchical structure where each group is a parent to either child groups or ultimately, items. Such a grouping scheme is herein referred to as a ‘grouping hierarchy’.

Certain sort orders may be associated with a particular pattern of grouping hierarchy based on common convention. An example of this is date based sort orders, which according to convention can be arranged into a grouping hierarchy of days, weeks, months, years etc. Another common grouping hierarchy derived from convention in music publishing is song, album, artist, genre. Alternatively, grouping hierarchies can be designed according the particular nature of content stored in a digital system, and may be arbitrarily structured. Grouping hierarchies may also be dynamically generated by the system based on a current data set, or generated by the user of the system. A common example of this last case is a hierarchical file system generated by a user using a command shell or file explorer.

When navigating a collection of items, one advantage of grouping the items is to enable faster traversal of the collection. As the items are grouped at higher levels of the grouping hierarchy, the speed of traversal increases, although the ability to select a position in the collection close to an individual target item decreases. Typically, the larger a collection of items, the more levels of grouping will be required in order to allow fast and effective traversal of the collection.

Whilst navigating a collection of items, a grouping level of zero or higher may be chosen by the user at any time, with a grouping level of zero corresponding to items being shown in a stack or list in an order determined by the current sort order; a grouping level of one corresponding to first level groups being shown in a stack or list in an order determined by the current sort order and so forth. At a grouping level of one or higher, one group is considered to be ‘in focus’, and the currently selected group. This is herein referred to as the ‘focus group’. Whilst the focus group ultimately contains the focus item, the two concepts are distinct.

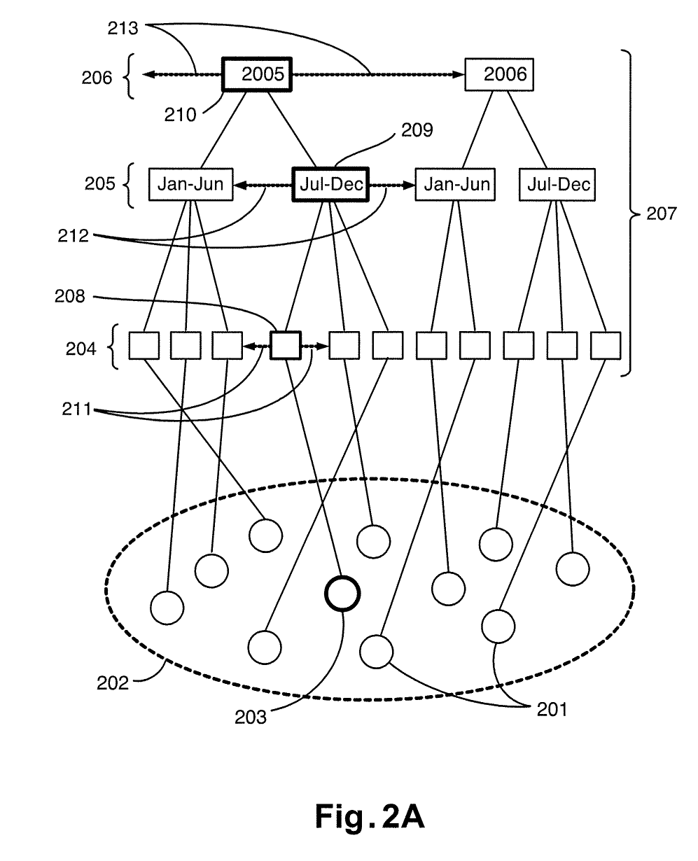

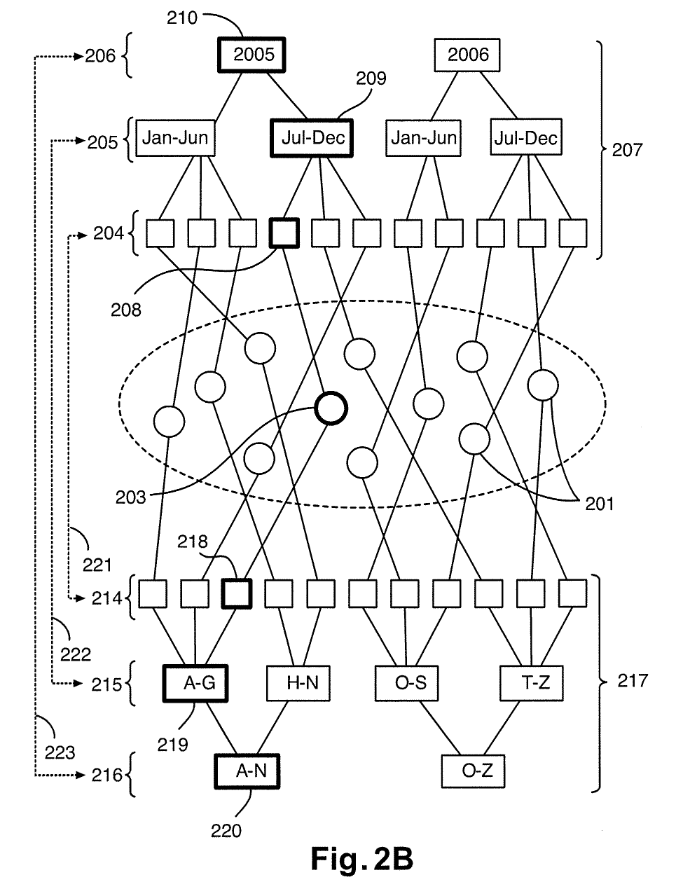

FIG. 2A is a schematic diagram representing a collection of items and a grouping hierarchy. A collection 202 includes a number of items 201, which need not be stored in an ordered form. A sort order 204 results in item mappings in which there is a one-to-one mapping between the item mappings and the items 201. The item mappings are sorted according to particular aspects. In this example the item mappings are sorted in date order. A first grouping level 205 consists of first level groups wherein there is a one-to-many mapping between the first level groups and the individual item mappings that comprise the sort order 204. A second grouping level 206 consists of second level groups wherein there is a one-to-many mapping between the second level groups and the first level groups that comprise the first grouping level 205. It is apparent from FIG. 2A that the order of groups at each level is ultimately determined by the order of the of individual item mappings, and hence by the current sort order.

The sort order 204, first grouping level 205 and second grouping level 206 collectively comprise a grouping hierarchy 207. It is to be appreciated that whilst the grouping hierarchy in this example consists of two grouping levels in addition to a sort order, a grouping hierarchy may contain any number of grouping levels in addition to a sort order.

One item in the collection 202, being item 203 in this example, is the focus item. An item mapping 208 in the sort order 204 corresponds to the focus item. Similarly, the first level group 209 corresponds to the focus item mapping 208, and the second level group 210 corresponds to the first level group 209. When navigating the collection 202 at any grouping level greater than zero, one group at that level can be determined to be the focus group based on the current focus item. For example, if the grouping level is two, which corresponds to the second grouping level 206, then group 210 will be the current focus group since it is the only parent group of the focus item 203 at that level.

It is possible to navigate between the grouping levels, for example from first level group 209 to second level group 210 or to item mapping 208, at any time. When navigating between grouping levels the focus item is always maintained.

While the current grouping level is zero, meaning that individual items are shown in a stack or list (for example upon the display 100), it is possible to navigate from the focus item mapping 208 to either the next or previous item in the sort order 204, as indicated by the arrows 211. This will result in the focus item changing to the item mapped to the respective item mapping in the sort order 204.

When the current grouping level is one or higher, it is possible to navigate to another group at that level, for example from the first level group 209 as indicated by the arrows 212 or from the second level group 210 as indicated by the arrows 213 (the previous second level group is not shown in FIG. 2A). When navigating to a new focus group at the same grouping level, the focus item 203 will change to an item that is contained in the new focus group. As such a means should be provided for selecting a default or representative item in the new focus group to become the new focus item.

A simple approach for selecting the representative item in a focus group is to use the first item in the group, based on the current sort order, or the middle or last item for example. In a preferred implementation, the most recent focus item is used as the representative item of the groups to which it belongs, and in all other cases the first item in the group is used as the representative item, based on the current sort order.

FIG. 2B is a schematic diagram representing a collection of items and a plurality of grouping hierarchies. In addition to date based hierarchy 207 described above, FIG. 2B additionally shows an alphabetical hierarchy 217 mapping to the same collection 202 of items 201. Whilst in this example only two grouping hierarchies are shown and each hierarchy contains two grouping levels in addition to a corresponding sort order, it is to be appreciated that any number of grouping hierarchies may be provided and that each grouping hierarchy may contain any number of grouping levels in addition to a sort order.

In the same way that the focus item 203 corresponds to focus item mapping 208, first level focus group 209 and second level focus group 210 in the grouping hierarchy 207, the focus item 203 also corresponds to item mapping 218, first level group 219 and second level group 220 of grouping hierarchy 217.

Furthermore, associative links are provided between levels of grouping hierarchies. In this example, associative link 221 links the sort order 204 of grouping hierarchy 207 with the sort order 214 of grouping hierarchy 217, associative link 222 links the first grouping level 205 of grouping hierarchy 207 with the first grouping level 215 of grouping hierarchy 217 and associative link 223 links the second grouping level 206 of grouping hierarchy 207 with the second grouping level 216 of grouping hierarchy 217.

The associative links 221, 222 and 223 can exist despite the respective grouping hierarchies relating to different aspects of the items in the collection. The ability to associate levels of otherwise unrelated grouping hierarchies with each other is another aspect of the present disclosure.

One advantage of associating levels of grouping hierarchies with each other is that the grouping hierarchy can be switched at any grouping level. Since every grouping hierarchy contains all of the items in the collection, it will also be possible to maintain the focus item whilst switching between grouping hierarchies. This allows continuous browsing across all levels of all grouping hierarchies, without the need to navigate out of one hierarchy before switching to another, as is commonly the case in the prior art.

There are a number of possible approaches for associating levels of grouping hierarchies with each other. One example is an ‘ordinal mapping’ scheme. According to an ordinal mapping scheme, levels of the grouping hierarchies are associated with each other based on the position of the levels in their respective hierarchies. For example, in FIG. 2B, first grouping level 205 of grouping hierarchy 207 and first grouping level 215 of grouping hierarchy 217 are associated with each other because they are both at the first level of their respective hierarchies, and second grouping levels 206 and 216 are associated because they are both at the second level of their respective hierarchies.

There is no need for all grouping hierarchies to contain an equal number of levels. In the case that grouping hierarchies contain unequal numbers of levels, the simple ordinal mapping scheme described above will fall short, since it is the intention that all levels of all grouping hierarchies should map to other grouping hierarchies to allow the switching of grouping hierarchies at any time.

A second example of a scheme for associating levels of grouping hierarchies with each other is a ‘magnitude mapping’ scheme. According to a magnitude mapping scheme, levels of grouping hierarchies are associated with each other based on the number of items in the groups. In a simple magnitude mapping scheme, grouping levels containing the closest average group size in linear terms will be associated. More sophisticated magnitude mapping schemes, such as a scheme based on orders of magnitude on a given scale, may be devised. An advantage of a magnitude mapping scheme is that the mappings between grouping levels can adapt depending on the particular content in a collection.

A third example of a scheme for associating levels of grouping hierarchies with each other is an ‘aliased mapping’ scheme. According to an aliased mapping scheme, a group hierarchy that contains less than the maximum number of grouping levels of all grouping hierarchies in the system will have aliases from the missing levels to levels that do exist in that grouping hierarchy. When switching to such a grouping hierarchy when the current grouping level is missing in that grouping hierarchy, the aliased grouping level will be made active instead. The current grouping level will not change at this point, only the apparent grouping level within that grouping hierarchy.

In a preferred implementation, a combination of the ‘ordinal mapping’ and ‘magnitude mapping’ schemes is used. According to this combined mapping scheme, the first levels of every grouping hierarchy map to each other, as do the highest levels. For example, the third level of a three-level grouping hierarchy will map to the fourth level of a four-level grouping hierarchy and vice-versa. All other levels are mapped according to the simple magnitude mapping scheme described above. An advantage of this combined mapping scheme is the ability to associate all levels of grouping hierarchies comprised of different numbers of levels whilst maintaining user expectations that lowest and highest levels will map to each other.

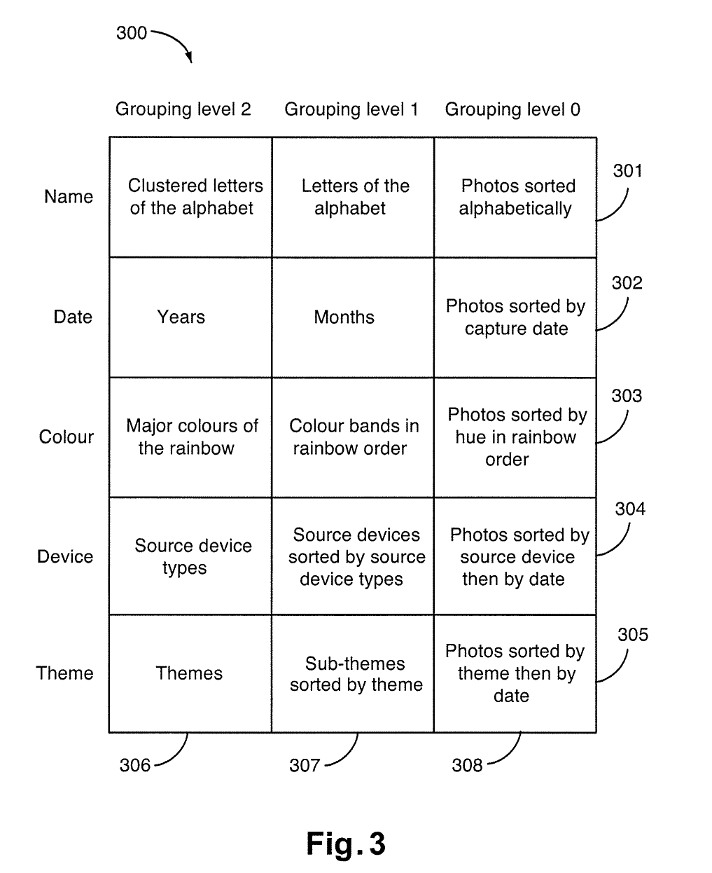

FIG. 3 is an exemplary table 300 of grouping hierarchies and grouping levels for browsing a collection of photos. Each cell in the table 300 represents a distinct browsing mode within the hierarchy of the system. Each of the rows 301, 302, 303, 304 and 305 of the table 300 represents a grouping hierarchy. The grouping hierarchy names (Name, Date, Colour, Device, Theme) shown to the left of each row may be applied to menus or other elements in the user interface, as will be described. Each of the columns 306, 307 and 308 represents a grouping level of each of the respective grouping hierarchies: column 308 represents grouping level zero, column 307 represents the first grouping level and column 306 represents the second grouping level. In this example, all of the grouping hierarchies contain an equal number of levels (3) so an ordinal mapping scheme may be applied between the levels of the grouping hierarchies.

Whilst browsing a collection of photos using the grouping hierarchies represented in table 300, at any time, one cell in the table will correspond to the current grouping hierarchy and grouping level of the system.

From any one cell in the table 300, it is possible to change to a browsing mode represented by any adjacent cell in either the horizontal or vertical direction. Changing the grouping level is analogous to moving to an adjacent cell in the horizontal direction, and changing to the next or previous grouping hierarchy is analogous to moving down or up in the vertical direction respectively whilst maintaining a corresponding grouping level depending on the mapping scheme in use.

For example, if the current system browsing mode corresponds to the cell at the intersection of row 303 and column 307 and labelled ‘Colour bands in rainbow order’, increasing the grouping level would result in a mode corresponding to the cell at row 303 and column 306 and labelled ‘Major colours of the rainbow’. Decreasing the grouping level would result in a mode corresponding to the cell at row 303 and column 308 and labelled ‘Photos sorted by hue in rainbow order’. Choosing the previous grouping hierarchy would result in a mode corresponding to the cell at row 302 and column 307 and labelled ‘Months’. Choosing the next grouping hierarchy would result in a mode corresponding to the cell at row 304 and column 307 and labelled ‘Source devices sorted by device type’. It would also be possible to choose any grouping hierarchy at any time depending on the type of user input system provided.

There are a variety of possible configurations for a user interface based on the navigation method described herein. The minimum requirements include a representation of at least one item or group, a means for representing a focus item or focus group, a means for navigating between items or groups in at least one direction, a means for changing the grouping level and a means for changing the grouping hierarchy.

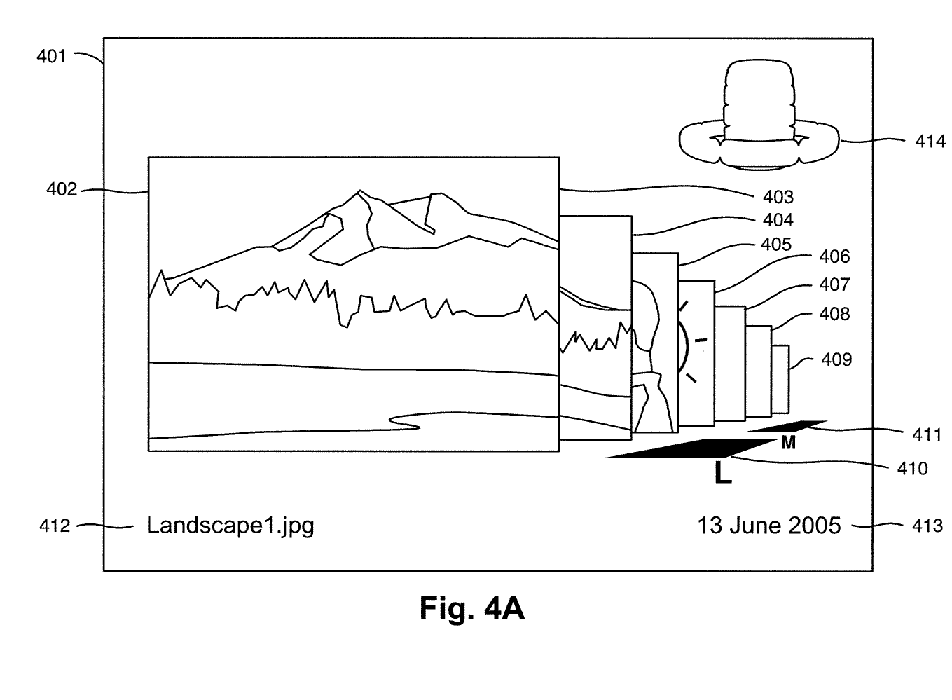

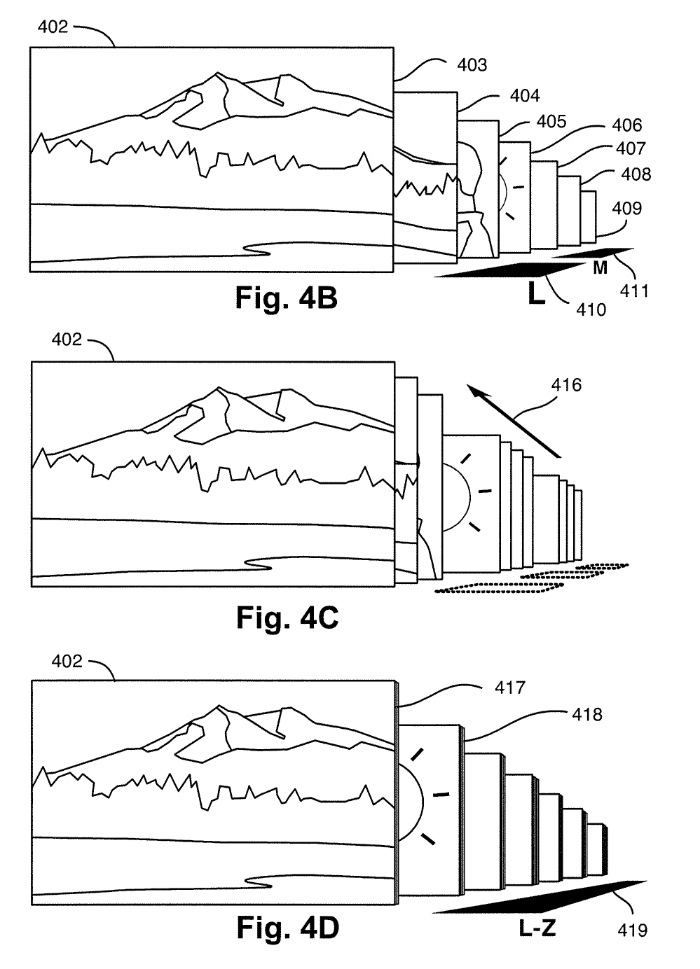

FIGS. 4A-4D illustrate an example of user interface of an image browser according to the present disclosure. The term ‘image’ may refer to a photo, illustration, video sequence, or a document representation of any other visual content. Referring to FIG. 4A, the display area 401 of the display 100 includes a sorted stack 402 of images 403-409 from a collection. It is to be appreciated that the collection may contain more items than can be shown in the display area 401 at one time, and thus the stack 402 generally shows a subset of the collection being browsed.

The front-most image 403 is the focus item of the collection and is referred to as the “focus image”. Metadata relating to the focus image 403 is shown at 412 and 413, being the file name and capture date respectively of the focus image in this example.

Grouping indicators 410 and 411 span the images in the stack 402 that belong to the same group at the next highest grouping level. In this example, the current grouping level is zero and the grouping indicators represent first level groups. Specifically, the grouping indicators 410 and 411 are the alphabet letters L and M respectively, clearing indicating the collection represented by the stack 402 has been sorted alphabetically. In other variations, additional grouping indicators representing higher level groups may be shown adjacent to the grouping indicators 410 and 411.

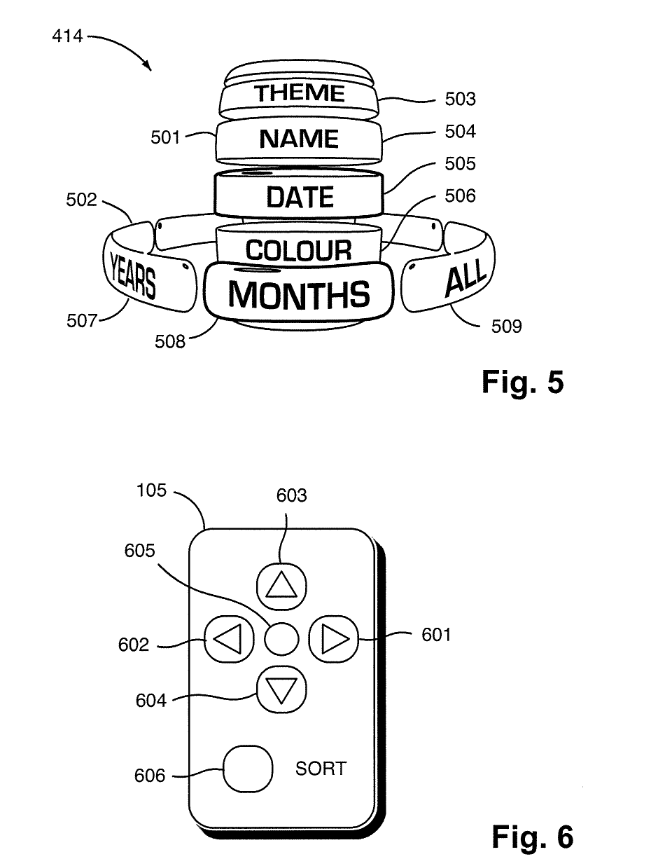

A graphical menu 414 gives user feedback as to the currently selected and pending grouping hierarchies and grouping levels. The menu 414 is discussed in greater detail with reference to FIG. 5.

FIGS. 4B-4D illustrate the transition of the stack 402 to a higher grouping level. As shown at FIG. 4B, the grouping level is zero and each item in the stack is an individual image. The grouping indicator 410 represents the first level ‘L’ group and includes images 403-405 and the grouping indicator 411 represents the first level ‘M’ group and includes images 406-409.

At FIG. 4C, the stack 402 is illustrated part way through an animated transition from grouping level zero to the first grouping level, and at FIG. 4D the stack 402 is shown at the first grouping level. The arrow 416 indicates the direction of movement of the images towards each other and towards the front of the stack to form ‘bundles’ of images representative of groups. The animated transition effect illustrated is referred to as a ‘concertina’ effect. Images 403-405 in FIG. 4B combine to form the group bundle 417 in FIG. 4D, and images 406-409 in FIG. 4B combine to form the group bundle 418 in FIG. 4D. First level grouping indicators 410 and 411 fade away through the transition, being replaced by second level grouping indicators such as 419 as the transition reaches the state shown at FIG. 4D. A similar transition will occur when increasing the grouping level from level one to level two for example, with the group bundles further combining to form higher level grouping bundles using a concertina transition.

The image which appears on the front of each group bundle is the representative item of the group and is referred to as the ‘representative image’. Assuming the focus image 403 was the current focus item at the time of increasing the grouping level, this image will remain as the representative image of its group, being the group represented by the bundle 417, until such time as the grouping level is changed again. For all other groups, the front-most image of each group will become the representative item of that group. If the grouping level is increasing from grouping level one or greater, the current representative image of the current focus group will become the representative image of the higher level group to which the focus group belongs. In the other cases the representative image of the front-most group of each higher level group will become the representative image of the higher level group.

As shown in FIG. 4D, the thickness of each of the bundles is proportional to the number of images that belong to the group represented by the bundle. However in practice the number of images per group may exceed the practical limit beyond which the bundles become too thick. Therefore the thickness of each bundle may be proportional to the number of images in the represented group on a non-linear scale such as a logarithmic scale whereby the change in thickness of the bundle per additional image decreases as the number of images in the group increases. Alternatively, a fixed thickness may be applied to all group bundles.

FIG. 5 illustrates the graphical menu 414 for choosing grouping hierarchies and grouping levels. The menu 414 includes a vertical ring 501 and a horizontal ring 502. The vertical and horizontal rings can rotate independently of each other to provide two levels of menu selection. The vertical ring 501 includes menu items 503-506 each of which represents a corresponding grouping hierarchy. Menu item 505 represents the currently selected grouping hierarchy, being ‘Date’ in this example. The horizontal ring 502 includes menu items 507, 508 and 509 each of which represents a grouping level within the current grouping hierarchy. Menu item 508 represents the currently selected grouping level, being the first grouping level ‘Months’ in this example. The selected menu items are shown towards the front of each respective ring and in a visually distinct manner from the non-selected menu items. In this example the selected items are distinguished from the other items by thicker lines. Colour may also be used to distinguish the items.

The horizontal ring 502 is arranged around a centre axis that intersects the centre axis of the vertical ring 501 however the horizontal ring lies on a plane that is offset from the centre axis of the vertical ring. This is so that the selected item 505, in addition to at least one item (such as item 504) above and one item (such as item 506) below the selected item on the vertical ring 501 are visible without being obscured by the horizontal ring 502.

The menu items 504 and 506 immediately above and below the currently selected grouping hierarchy menu item 505 indicate to the user of the browsing application which grouping hierarchy will next be selected in the respective vertical direction. Similarly the menu items 507 and 509 to the left and right of the currently selected grouping level menu item 508 indicate to the user which grouping level will next be selected in the respective horizontal direction. In some cases no further options are available on the menu in a given direction. For example, should the menu item 509 labelled ‘All’, representing the zero grouping level, be the currently selected item then there will be no further options in the right hand direction since zero is the minimum grouping level. In this case the menu item will be shown in a visually distinct manner to indicate that the menu item does not represent a selectable option, or may be omitted altogether.

Operation of the graphical menu 414 is achieved by using the control device 105 as described with reference to FIG. 6.

FIG. 6 illustrates the control device 105 to be used in conjunction with the user interface of the browsing application. Two buttons 603 and 604 control the selection of the focus item in the stack. Momentarily pressing the button 603 on the control device 105 will cause the stack 402 to move towards the user by the distance of one image. The image 404 will then become the focus image taking the place of the image 403 and the image 403 will disappear off the front of the stack. Similarly, momentarily pressing the button 604 will cause the stack to move away from the user by the distance of one image. In alternate implementations the stack may continue in another trajectory away from the focus image so that images in both directions in relation to the focus image are visible.

Pressing and holding either button 603 or 604 will cause the stack 402 to move continuously towards or away from the user respectively until the button is released, at which time the stack will stop moving and the image most closely aligned with front of the stack will become the new focus image. In a preferred implementation the stack velocity will increase with time whilst the button is held, up to a pre-determined maximum velocity, and will decelerate to zero velocity at a pre-determined rate upon releasing the button.

Two further navigation buttons 601 and 602 control the selection of the grouping level. Pressing the button 602 will cause the grouping level to increase by one. Referring to FIG. 5, this will cause the horizontal ring 502 of the graphical menu 414 to rotate such that the menu item 507, being the menu item to the left of the selected menu item 508, takes the position of the selected menu item 508. Simultaneously, the stack 402 will undergo a transition such as described with reference to FIGS. 4B-4D. Similarly, pressing the button 601 will cause the grouping level to decrease by one, with the resulting transitions occurring in the opposite direction.

Should the grouping level already be the maximum grouping level for the currently selected grouping hierarchy, pressing the button 602 will have no effect. Should the grouping level already be zero, pressing the button 601 will have no effect.

A button 606 controls the selection of grouping hierarchies, effectively by selecting an alternate sort parameter. Pressing the button 606 will cause the next grouping hierarchy in a sequence of grouping hierarchies to be selected. Referring to FIG. 5, this will cause the vertical ring 501 of the graphical menu 414 to rotate such that the menu item 506, being the menu item below the selected menu item 505, takes the position of the selected menu item 505. Simultaneously, the images or groups in the stack 402 will be re-sorted around the focus image 403 or focus group 417. Depending on the particular attributes of the images and on the grouping hierarchies, this may result in some or all of the images or groups represented in the stack to change, with the exception of the focus image 403 or the focus group 417 which most desirably remain constant when changing grouping hierarchies. After reaching the last grouping hierarchy in the sequence the next press of the button 606 will result in the first grouping hierarchy being selected.

In alternate implementations, a complementary button may be provided to button 606 to allow navigation of the sequence of grouping hierarchies in both directions. Alternatively, a random selection of grouping hierarchies may be applied. Further, grouping hierarchies may be selected from a set of dedicated buttons on the user interface or on a control device, or by a range of other means.

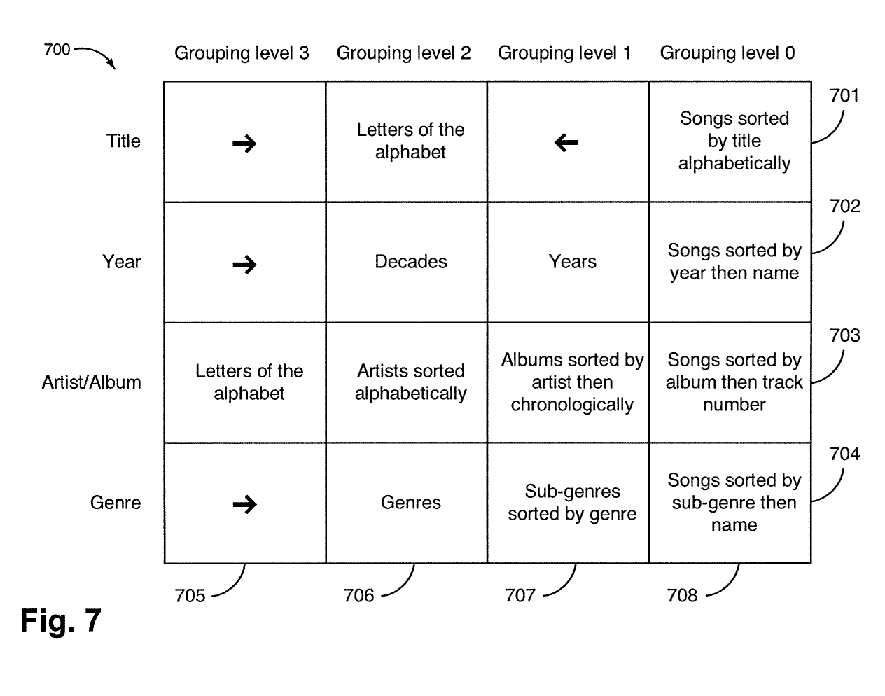

FIG. 7 is an exemplary table of grouping hierarchies and grouping levels for browsing a collection of songs. Each cell in the table 700 represents a distinct browsing mode within the system. Each of the rows 701, 702, 703 and 704 of the table 700 represents a grouping hierarchy. The grouping hierarchy names shown to the left of each row may be applied to menus or other elements in the corresponding user interface. Each of the columns 705, 706, 707 and 708 represents a grouping level of each of the respective grouping hierarchies: column 708 represents grouping level zero, column 707 represents the first grouping level, column 706 represents the second grouping level and column 705 represents the third grouping level.

In this example, the grouping hierarchies contain an unequal number of levels and an aliased mapping scheme is applied. For example, the cell at row 701 and column 707 shows an arrow pointing in the left hand direction, towards the adjacent cell column 706 of the same row. This indicates that grouping level one of the ‘Title’ grouping hierarchy is aliased to grouping level 2 of the same grouping hierarchy. For example when switching from the mode represented by the cell at row 702 and column 707 and labelled ‘Years’ to the ‘Title’ grouping hierarchy as represented by row 701, the apparent result will be the mode represented by the cell at row 701 and column 706 and labelled ‘Letters of the alphabet’. The grouping level will be still be 1 however and therefore switching back to the ‘Year’ grouping hierarchy as represented by row 702 will return to the mode represented by the cell at row 702 and column 707 and labelled ‘Years’. The grouping level can only be changed by direct control.

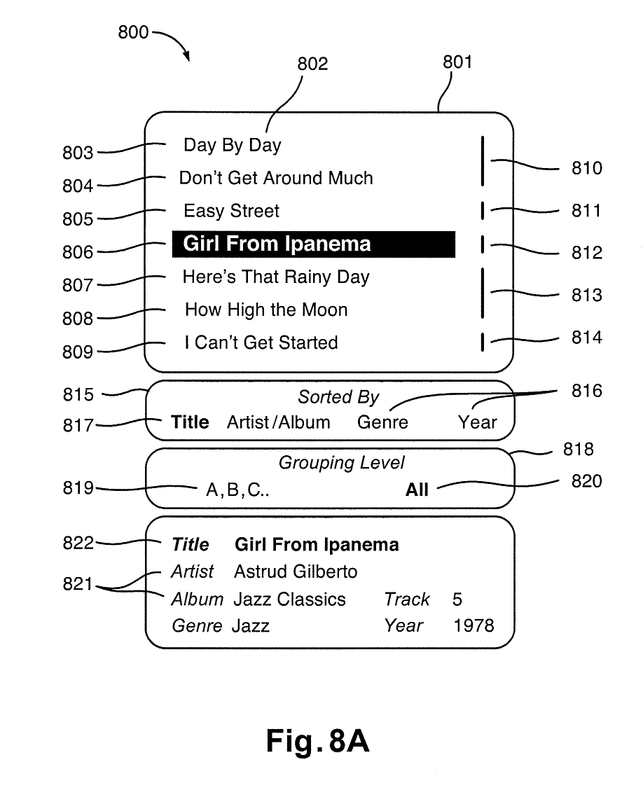

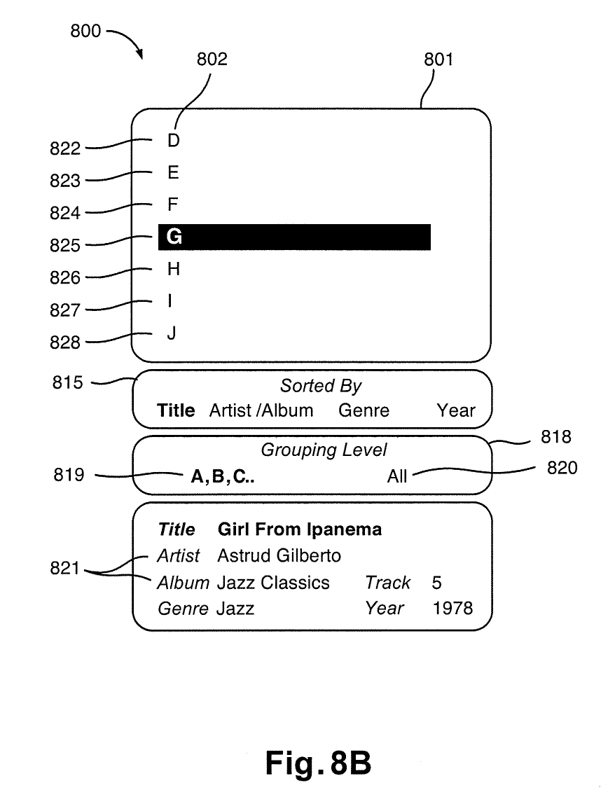

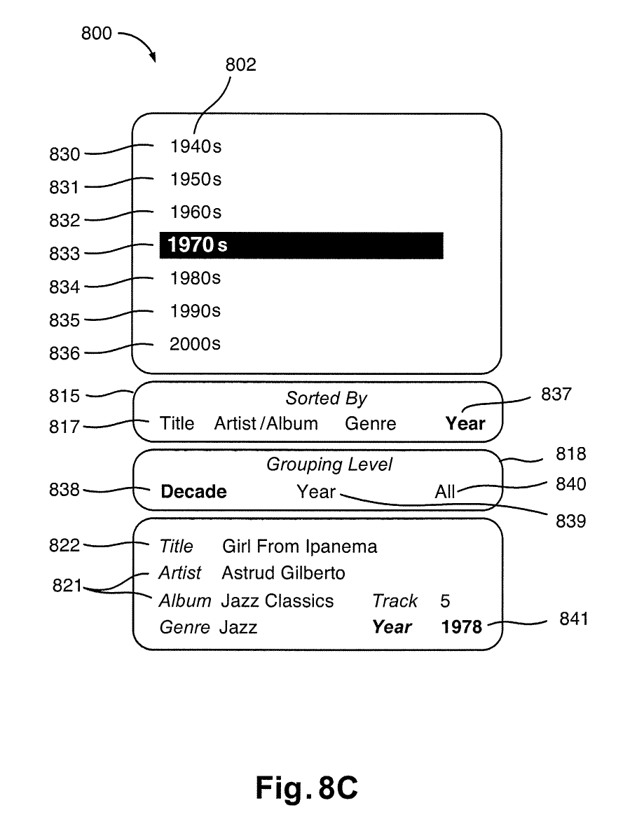

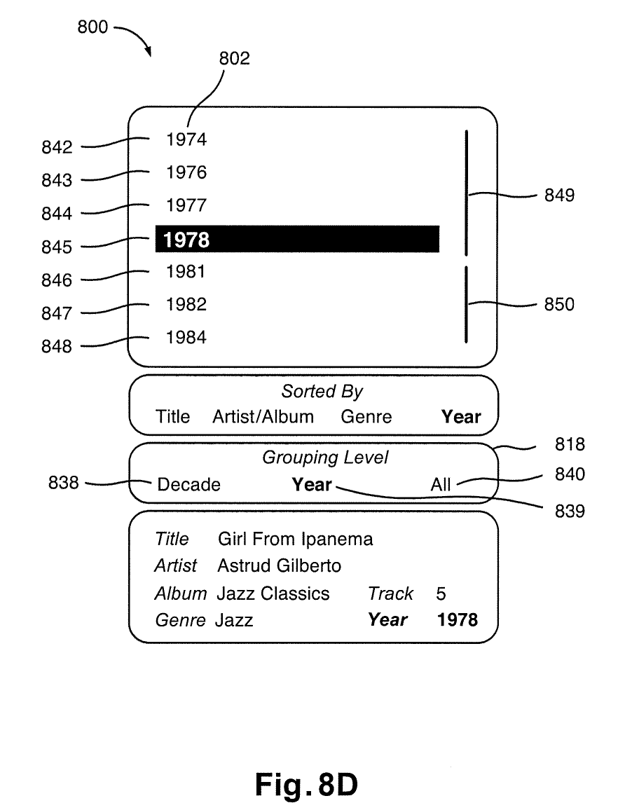

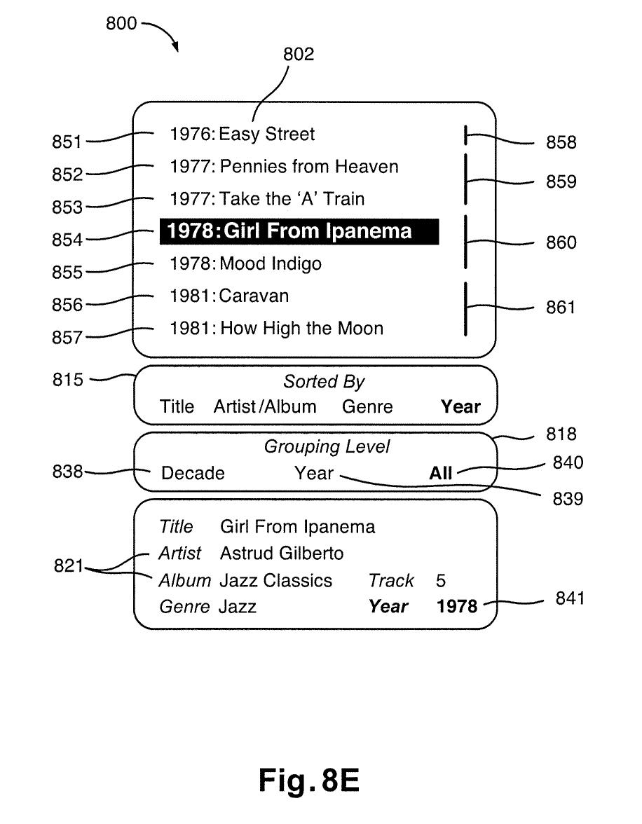

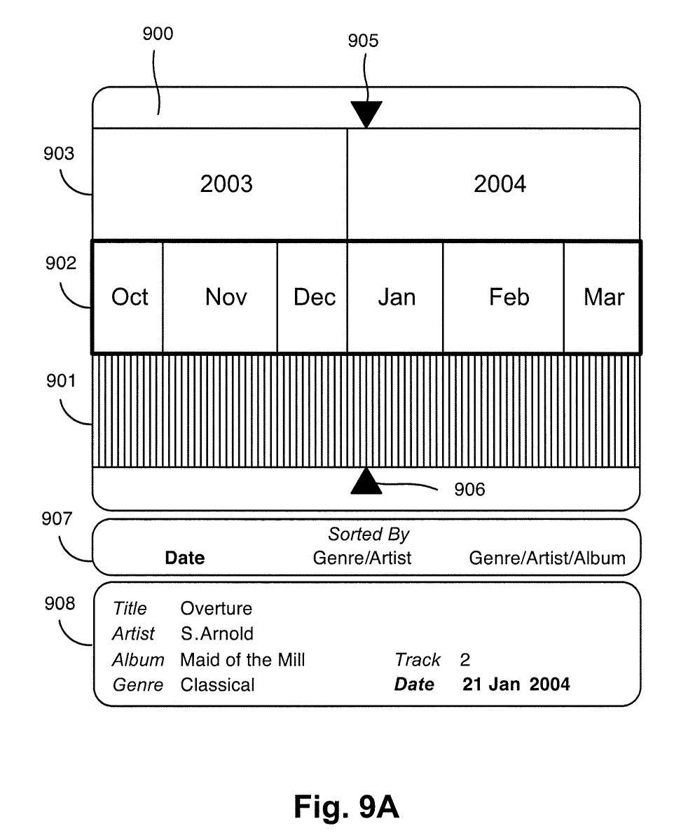

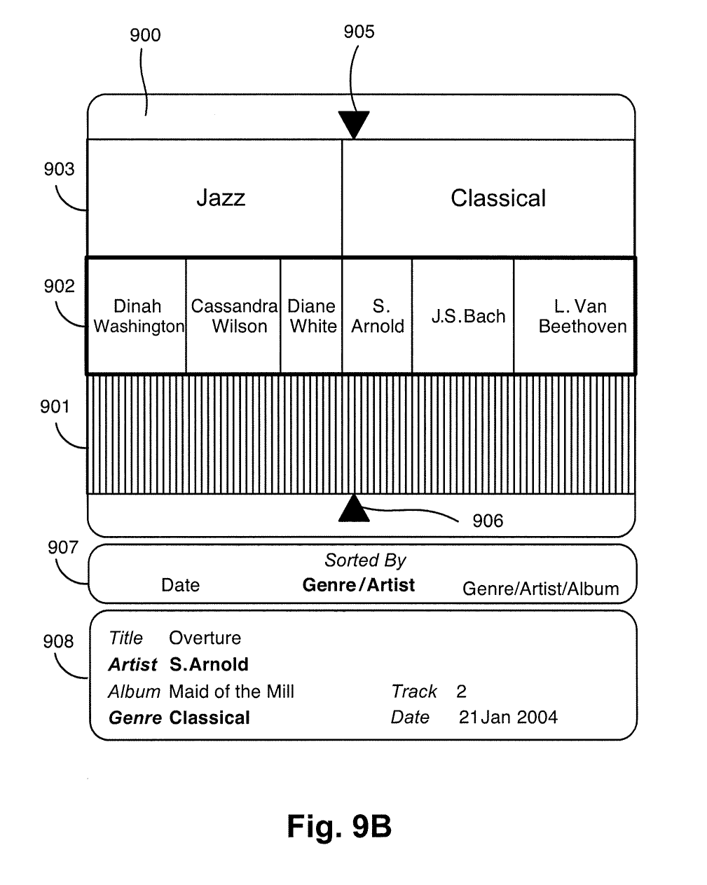

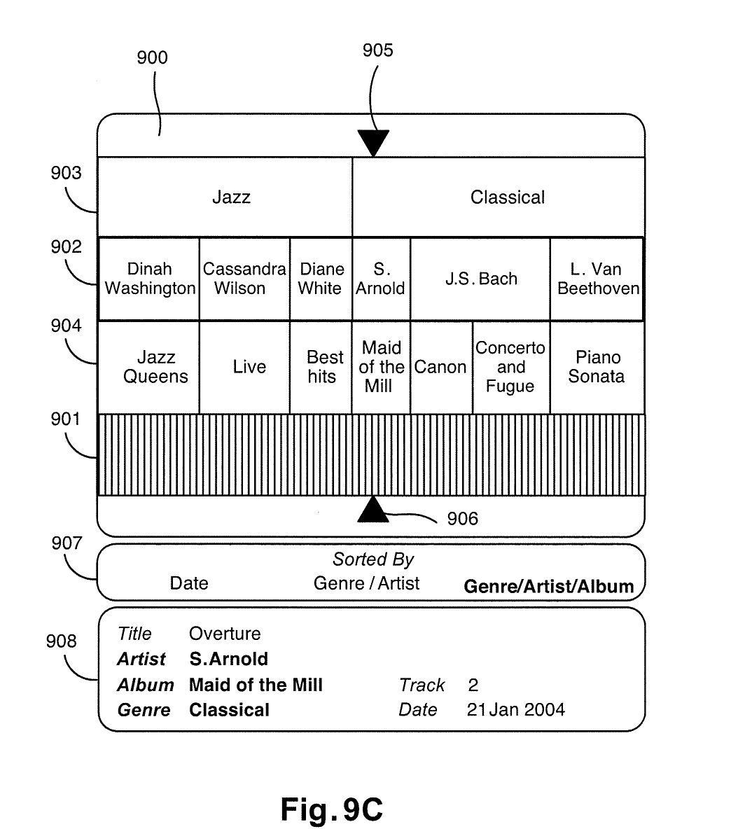

FIGS. 8A-8E illustrate an example user interface of a music browser according to the present disclosure. Referring to FIG. 8A, a displayable user interface 800 includes a first display area 801 within which a list 802 of items 803-809 from a collection can be viewed. It is to be appreciated that the collection may contain more items than can be shown in the display area 801 at one time, and thus the list 802 will generally show a subset of the collection being browsed.

A focus item 806 is indicated in reverse video text. A position in the display area 801, which is preferably fixed, that is occupied by the focus item 806 is referred to as the ‘focus position’. The focus item can also be indicated by a change in formatting such as colour or font style, by a visible border or by an icon on the display. Alternatively the focus item may be indicated implicitly by the position on the display or by markings on the surround of the hardware of which the display is part. The indication of focus may additionally indicate the selection of the focus item which is pertinent for other functions which might be activated, such as playing a song or modifying a picture. For example, pressing the button 605 of the control device 105 will cause the song represented by the current focus item to begin to play and be acoustically reproduced, for example via the loudspeakers 1117 if implemented in the computer system 1100.

A grouping hierarchy menu 815 occupies a further display area and includes menu items 816 and a selected menu item 817, each of which represents a grouping hierarchy. The selected menu item 817 is visually distinguished from the other menu items by being in a bold font in this example. This indicates that the grouping hierarchy named ‘Title’ (as represented by row 701 of table 700) is the current grouping hierarchy.

A grouping level menu 818 occupies a further display area and includes menu items 819 and a selected menu item 820, each of which represents a grouping level of the currently selected grouping hierarchy. The selected menu item 820 is visually distinguished from the other menu items by being in a bold font in this example. This indicates that the grouping level named ‘All’ (being grouping level zero in this example) is the current grouping level.

Metadata items 821 relate to the focus item 806 and are shown in a further display area. Metadata item 822, ‘Title’ is visually distinguished from the other metadata fields by being in a bold font in this example. This is because ‘Title’ metadata is an aspect on which the current grouping hierarchy is based.

Grouping indicators 810-814 span the items in the list that belong to the same group at the next higher grouping level. In this example, the current grouping level is zero and the grouping indicators represent second level groups. The second grouping level is the next higher grouping level since there is no first grouping level in the ‘Title’ grouping hierarchy as represented by row 701 of table 700. By way of example, the grouping indicator 810 represents the group of items whose titles begin with the letter ‘D’. In alternate configurations the grouping indicators 810-814 may be represented as shading of the items in the list or labels may be shown in conjunction with the grouping indicators. In other variations, additional grouping indicators representing higher level groups may be shown adjacent to the grouping indicators.

The buttons 603 and 604 of the control device 105 control the selection of the focus item in the list. Momentarily pressing the button 603 will cause the list 802 to move down by the distance of one item in relation to display area 801. The item 805 will then become the focus item and the item 809 will scroll off the bottom of the display area 801, being replaced at the top of the visible portion of the list by the item immediately preceding item 803. Momentarily pressing the button 604 whilst in this latter state will cause the list to return to the state shown in FIG. 8A.

Pressing and holding either button 603 or 604 will cause the list 802 to scroll continuously in either the down or up direction respectively until said button is released, at which time the list will stop scrolling and the item most closely aligned with the focus position will become the new focus item. Preferably, the continuous scrolling velocity will increase with time whilst said button is held, up to a pre-determined maximum velocity, and will decelerate to zero velocity at a pre-determined rate upon releasing said button.

The buttons 601 and 602 control the selection of the grouping level. Pressing the button 602 will cause the grouping level to increase to the next higher grouping level. For example, the items in the item list 802 as shown in FIG. 8A are sorted alphabetically by title at grouping level zero. Referring to FIG. 8B, subsequent to pressing the button 602, the items 822-828 in the list 802 now correspond to a subset of the list of letters ‘A’ through to ‘Z’. This is the second level grouping of alphabetically sorted items which is the next higher grouping level of the ‘Title’ grouping hierarchy in this example. The focus group 806 is now the group ‘G’, which is the group that contains the focus item entitled ‘Girl from Ipanema’. The focus group 815 preferably occupies the same position in the display area 801 as the focus item 806. Since this is also the highest grouping level in the current grouping hierarchy, no grouping indicators are shown.

Note that the item entitled ‘Girl from Ipanema’ is still the focus item in FIG. 8B and the metadata values shown at 821 thus remain the same since these values always correspond to the focus item. In other variations, metadata relating to the focus group may be shown in addition to metadata relating to the focus item.

The grouping level menu item 819 is now the selected menu item in place of menu item 820 which was previously selected.

Pressing the button 601 whilst in the latter state will cause the grouping level to decrease to the next lower grouping level in the grouping hierarchy whilst maintaining the focus item, in this case returning the user interface to the state shown in FIG. 8A.

If the grouping level is already the highest grouping level in the current grouping hierarchy then pressing button 602 will have no effect; and if the grouping level is level zero as illustrated in FIG. 8A then pressing the button 601 will have no effect.

The button 606 controls the selection of grouping hierarchies. Pressing the button 606 will cause the next grouping hierarchy in a sequence of grouping hierarchies to be selected. After reaching the last grouping hierarchy in the sequence the next press of the button 606 will result in the first grouping hierarchy in the same sequence being selected. For example, the items in the item list 802 as shown in FIG. 8B are second level groups of the ‘Title’ grouping hierarchy. Referring to FIG. 8C, subsequent to pressing the button 606 the items 830-836 in the list 802 now correspond to decades, which are second level groups of the ‘Year’ grouping hierarchy. The focus group 833 is now the group ‘1970s’, which is the group that contains the focus item ‘Girl from Ipanema’.

The menu item 837 is now the selected menu item in the grouping hierarchies menu 815 in place of the menu item 817. The grouping levels menu 818 contains new menu items 838-840 of which menu item 838 is the selected menu item.

Whilst the item entitled ‘Girl from Ipanema’ is still the focus item and the metadata values at 821 thus remain the same, now the metadata item 841 ‘Year’ is visually distinguished from the other metadata fields because ‘Year’ metadata is an aspect on which the new grouping hierarchy is based.

In alternate implementations, a complementary button may be provided to button 606 to allow navigation of the sequence of grouping hierarchies in both directions. Further, a random selection of grouping hierarchies may be applied. In still further implementations, grouping hierarchies may be selected from a set of dedicated buttons on the user interface or on a control device, or by a range of other means.

Pressing the button 601 whilst the user interface is in the state shown in FIG. 8C will cause the grouping level to decrease to the next lower grouping level in the current grouping hierarchy. Referring to FIG. 8D, subsequent to pressing the button 601 the items 842-848 in the list 802 now correspond to years, which are first level groups of the ‘Year’ grouping hierarchy. The focus group 845 is now the group ‘1978’, which is the group that contains the focus item ‘Girl from Ipanema’. The menu item 839 in the grouping level menu 818 is now the selected menu item in the place of the menu item 838.

Grouping indicators 849 and 850 span the items in the list that belong to the same group at the next highest grouping level. In this example, the current grouping level is one and the grouping indicators represent second level groups. By way of example, the grouping indicator 849 represents the ‘1970s’ decade group.

Pressing button 602 whilst in the latter state will cause the grouping level to increase again whilst maintaining the focus item, returning the user interface to the state shown in FIG. 8C.

Pressing the button 601 whilst the user interface is in the state shown in FIG. 8D will again cause the grouping level to decrease to the next lower grouping level in the current grouping hierarchy. Referring to FIG. 8E, subsequent to pressing the button 601 the items 851-857 in the list 802 are sorted by year at grouping level zero.

In this example the text of the items 851-857 includes reference to the year of each item. This is to aid in representing the current sort order to the user.

The focus item 854 is once again and remains ‘Girl from Ipanema’. The menu item 840 in the grouping level menu 818 is now the selected menu item in the place of the menu item 839.

Grouping indicators 858-861 span the items in the list that belong to the same group at the next higher grouping level. In this example, the current grouping level is zero and the grouping indicators represent first level groups. By way of example, the grouping indicator 858 represents the ‘1976’ year group.

In the example as shown in FIG. 8D it can be noted that some years in the list of year groups have been omitted, for example the year ‘1975’. This is because there are no items in the collection that correspond to this group. If a group containing zero items was selected as the focus group, then it would not be possible to determine a focus item that was a member of that group. In an alternate implementation, groups containing zero items are still shown in the list but are not selectable as the focus group, instead being skipped when navigating the list of groups.

FIGS. 9A-9C illustrate an alternate user interface of a music browser. In this alternate user interface, some or all levels of the currently selected grouping hierarchy are displayed concurrently in parallel rows that may be scrolled horizontally. In a similar fashion, the user interface may also be arranged as columns scrolled vertically, or along any other parallel trajectories in 2D or 3D space.

Referring to FIG. 9A, a display area 900 includes rows 901, 902 and 903 which collectively represent a hierarchical view of a portion of the collection of items. In this example row 901 represents grouping level zero, row 902 represents the first level groups containing the items in row 901 and row 903 represents the second level groups containing the first level groups in row 902. Each cell in each of the rows represents one item, in row 901; or one group at the respective grouping level in rows 902 and 903. The boundaries of the cells in the rows 901, 902 and 903 are horizontally aligned with respect to the corresponding items in the rows above and/or below.

An upper focus indicator 905 and a lower focus indicator 906 together indicate the current focus item and concurrently the focus groups at each level of the grouping hierarchy. Both upper and lower focus indicators 905 and 906 are provided since it would be difficult to visually project the focus position from a single focus indicator through multiple rows. In alternate implementations, a line or similar indicator passing vertically through all rows may be used.

The user of the user interface is able to scroll the contents of the rows 901-903 concurrently with respect to the focus indicators in order to view and select other items or groups in the collection. Row 902 is shown with a dark border, indicating that the row 902 corresponds to the currently selected grouping level, being the first level ‘Months’ of a grouping hierarchy in this example. The rate of scrolling of the contents of the rows 901-903 depends on which grouping level is currently selected. In this example, scrolling will occur in units of one month. Selecting the second grouping level as represented by row 903 will result in subsequent scrolling operations being in units of one year.

A grouping hierarchy menu 907 contains menu items representing the grouping hierarchies in the system, with the selected grouping hierarchy shown in a visually distinct manner. Metadata is shown in a display area 908 corresponding to the current focus item, with metadata items that relate to the current grouping hierarchy being shown in a visually distinct manner.

Selecting a new sort order and grouping hierarchy will cause the view in the display area to change accordingly. FIG. 9B is an example of the user interface when a grouping hierarchy of song, artist, and genre is selected.

This alternate user interface is not limited to grouping hierarchies with the same number of grouping levels. FIG. 9C shows the same collection arranged according to a grouping hierarchy of song, album, artist, genre such that an extra row 904 corresponding to the extra grouping level is included.

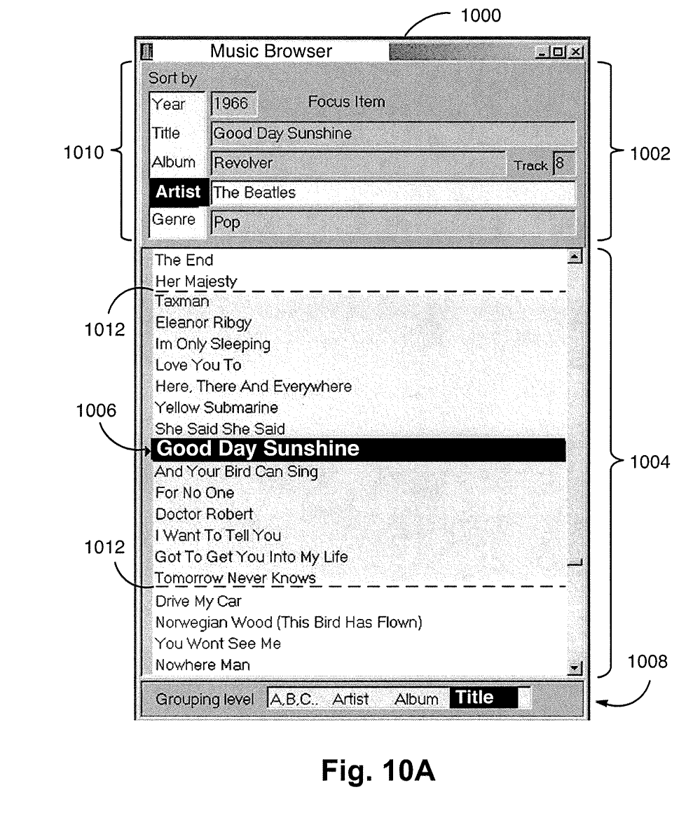

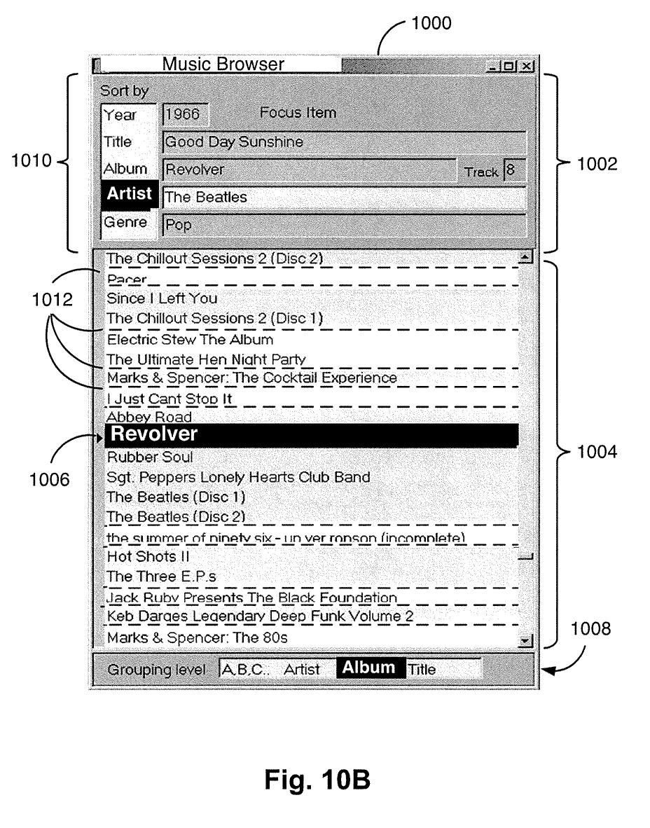

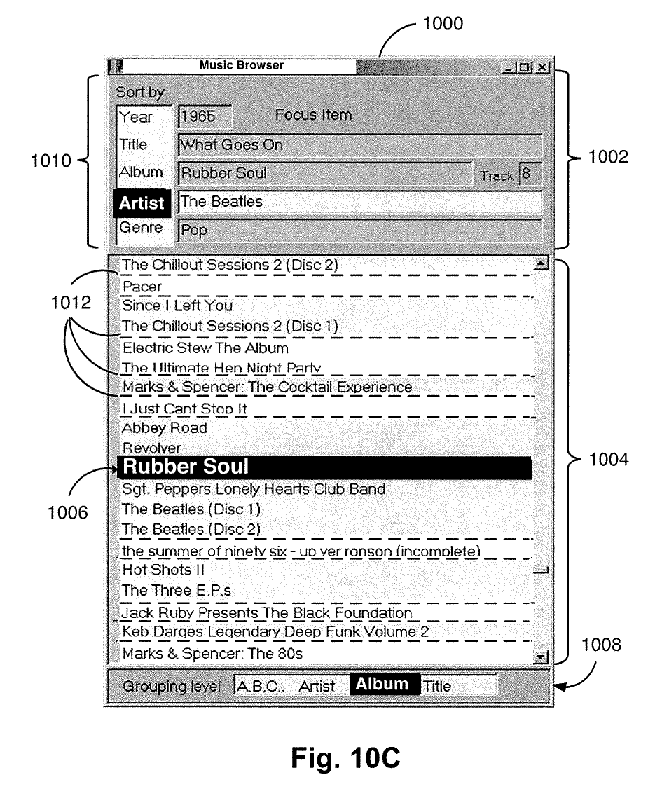

FIGS. 10A-10C shows an alternate displayable interface. This specific implementation is for a music collection database such as may be found to support or operate within portable-personal audio reproduction devices, often known as “MP3 players”, which typically include a liquid crystal display component. The interface 1000 includes a section 1002 for displaying details of the focus item, a scrollable list 1004 of items including a display location 1006 at which the focus item is identified, and a scrollable list 1008 of grouping levels, each represented by a displayed group name or identifier (eg. A, B, C . . . , Artist, album, Title). Further, a scrollable list 1010 is provided for selecting a desired sort order based upon the metadata associated with the items of the music collection, again represented by a displayed sort name or identifier (Year, Title, Album, Artist, Genre).

Not shown in FIGS. 10A-10C are user operable controls for scrolling and selecting items in the interface 1000. These have been omitted for clarity but can be implemented by any appropriate combination of the keyboard 1102, mouse pointer 1103, or the control device 105 of FIG. 6.

The particular display of FIG. 10A may be one that is encountered when the interface 1000 is initially enabled. In one implementation the application program can retain and recall the previously used sort order and use that order for a representative item or group from the collection. In the present case the sort order is “Artist” and the representative artist selected is “The Beatles”, for example because that artist has the largest number of songs in the stored collection. Since the sort order is “Artist”, items for that artist are then displayed in the scrollable list 1004 ordered in line with the corresponding group hierarchies. For example, albums are sorted in alphabetical order and grouped by artist. Artists are arrangement in alphabetical order. In FIG. 10A, the item “Good Day Sunshine” is located at the focus item location 1006, and details of that item are shown in the section 1002. The grouping level of “Title” is seen selected corresponding to the type of data shown in the list 1004. The interface 1000 also includes indicators 1012 which separate the listed collection based upon the next grouping level. In the present case, the selected grouping level is ‘Title’ and thus the next grouping level is album. The indicators 1012 in FIG. 10A thereby act to separate the titles in the list 1004 into their respective alums. Colour or shading may also be used. Since the sort category in FIG. 10A is ‘Artist’, the titles in the album (ie. ‘Revolver’) corresponding to the focus item 1006 (‘Good Day Sunshine’) are listed not in alphabetical order, but in the order those titles appear in the album, by track number.

FIG. 10B shows the result of changing the grouping level in the list 1008 from ‘Title’ to ‘Album’. The list 1004 has changed to show various albums produced by The Beatles and the album ‘Revolver’ is indicated at the focus location as that album is that which contains the focus item “Good Day Sunshine”, which continues to be represented in the section 1002. Since the sort section in the list 1010 remains “Artist”, the displayed list 1004 is sorted, for each artist alphabetically, as illustrated with the indicators 1012 separating the various artists.

FIG. 10C shows the change in the user interface 1000 where the user scrolls the list 1004 of FIG. 10B down by one album to select the album ‘Rubber Soul’. Note that the details of the focus item have changed in the section 1002 to now indicate details for a title ‘What Goes On’ in the album ‘Rubber Soul’ by “The Beatles’. In this example, ‘What Goes On’ would be one track on that album, and hence it's automatic selection as the new focus item.

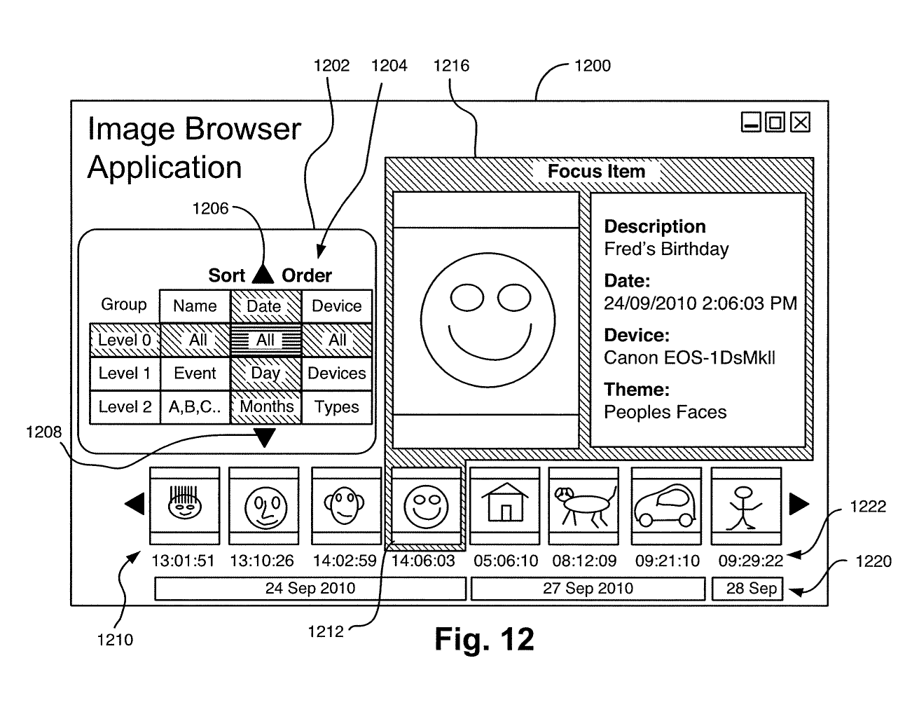

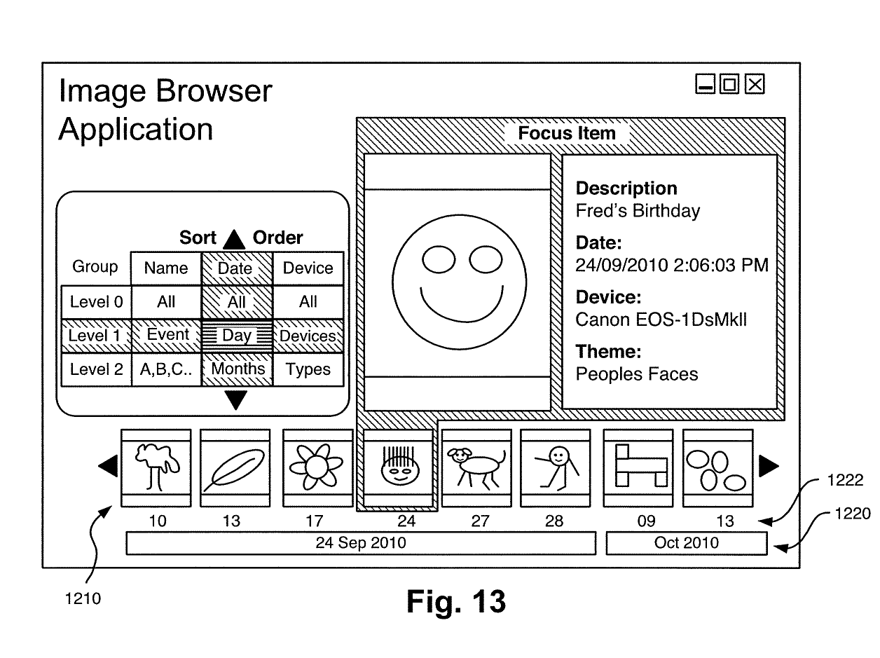

FIGS. 12 and 13 show a graphical user interface (GUI) 1200 developed for the browsing of a photographic collection and which desirably is represented upon the display 1114 of the computer system 1100 and controllable by user commands received via the keyboard 102 and mouse pointer 103. Alternatively such may be implemented with a HDTV device and operated using a remote control device, like that described above. The GUI 1200 includes a sorting and grouping section 1202 arranged in a fashion similar to the table of FIGS. 3 and 7. In this example, the sort order heads columns of a table 1204 with the selectable grouping associable with each sort order being shown in the rows of the table 1204. Icons 1206 and 1208 indicate if further groups are available for selection. Where implemented in the computer system 1100, the icons 1206 and 1208 may be selectable to scroll the groups. In an implementation with a handle held remote control device, the icons can represent visual prompts for the user to indicate a button to press.

The collection of photographs is presented as a list 1210 of thumbnail images with a certain thumbnail image residing in a specific display location 1212 in the list 1210. That location establishes or identifies the focus item which is shown in greater detail in a display section 1214 at a higher resolution 1216 and associated with a metadata description 1218 of attributes associated with the particular photograph.

In the example of FIG. 12, the selected sort order is “Date” and the group “All” is selected, as indicated by the highlighted intersection of the rows and column of the table 1204. As such all photographs in the collection able to be shown in the list 1210 sorted according to date. FIG. 12 also shows a date list 1220 representing the date upon which the corresponding photographs were captured, as this is the next highest grouping level in the grouping section 1202. The date list 1220 is appropriately ordered, and a sub-ordering 1222 of the list 1210 includes the times at which the photos were captured.

FIG. 13 shows the result of changing the grouping from “All” to “Days” within the same “Date” order. The list 1220 has reverted to months whereas the list 1222 shows the individual days upon which photos were captured. Note again that the focus item remains unchanged from FIG. 12, even though, in this example, a representative photograph for the date “24 Sep. 2010” has been displayed in the list 1210. This aspect is further seen in respect of the date “27 Sep. 2010” where, from FIG. 12, three photos are seen to have been captured on that date, and from FIG. 13, the representative photo shown for that date is that which is found in the middle of that group. Alternatively, the representative photo could be the first in the group or the last viewed in that group.

The table 1204 of FIGS. 12 and 13 provides an alternate user interface whereby the available sort order and groups are directly selectable by obtaining an appropriate intersection of a row and a column, to thereby reveal alternate selections of photographs from the list 1210 and from which a different focus item may be selected. In FIGS. 12 and 13, the rows specify corresponding grouping levels, with three levels being shown.

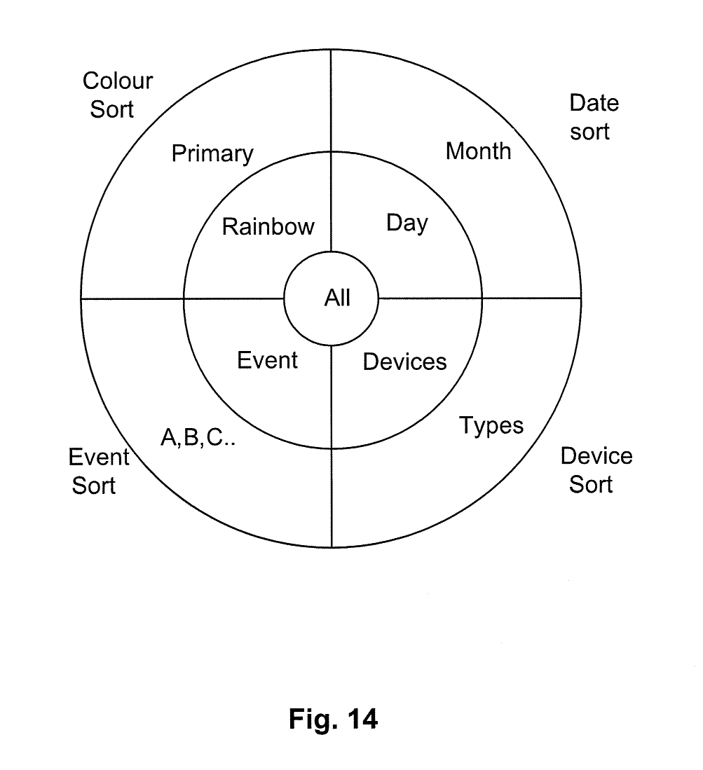

It is observed from FIGS. 12 and 13 that for each sort order, all have a common grouping level of “All”. Since the group at this level (eg. level 0) is the same for all sort orders, it is possible to vary the navigation control to the form shown in FIG. 14 where the groupings are formed by concentric rings about the common grouping “All”. Other groupings may be included as appropriate and as illustrated.

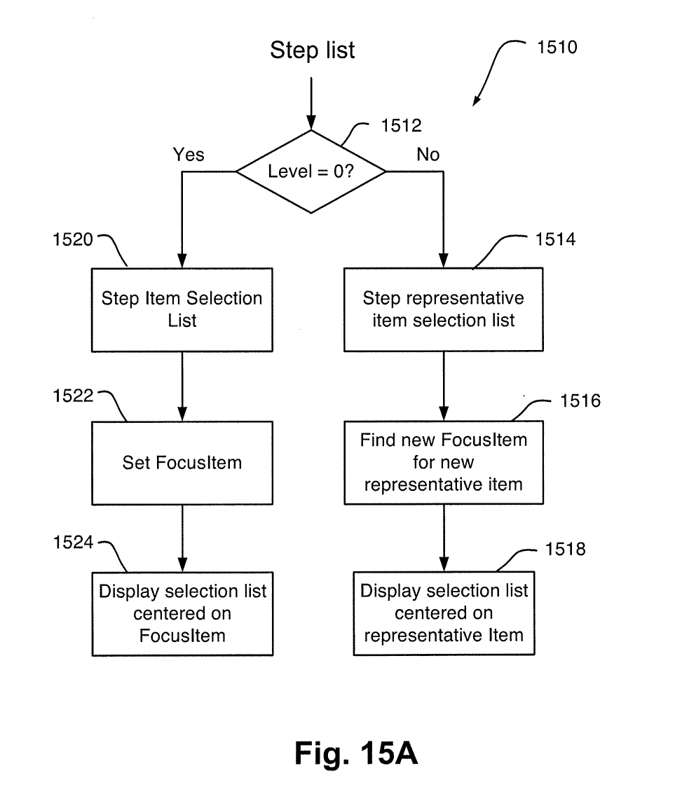

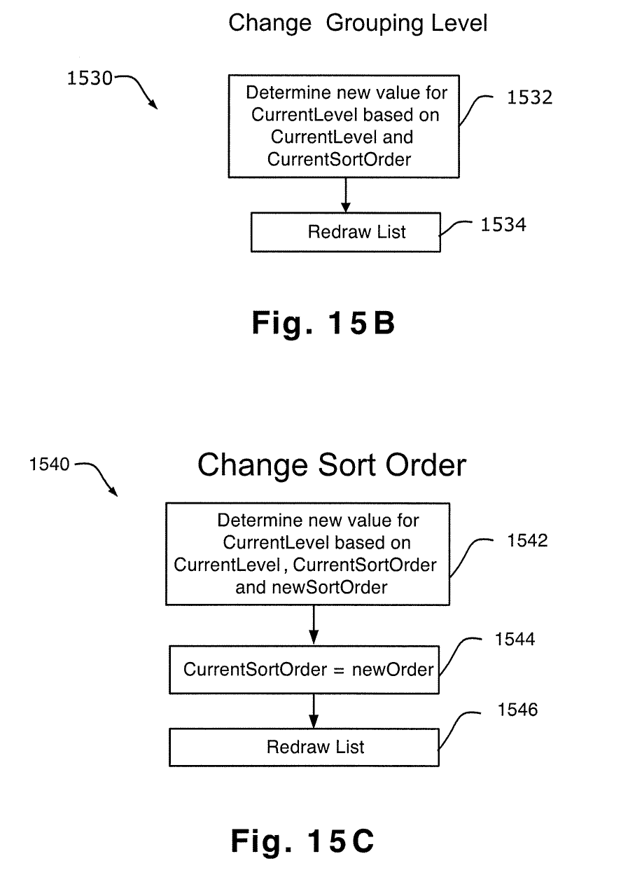

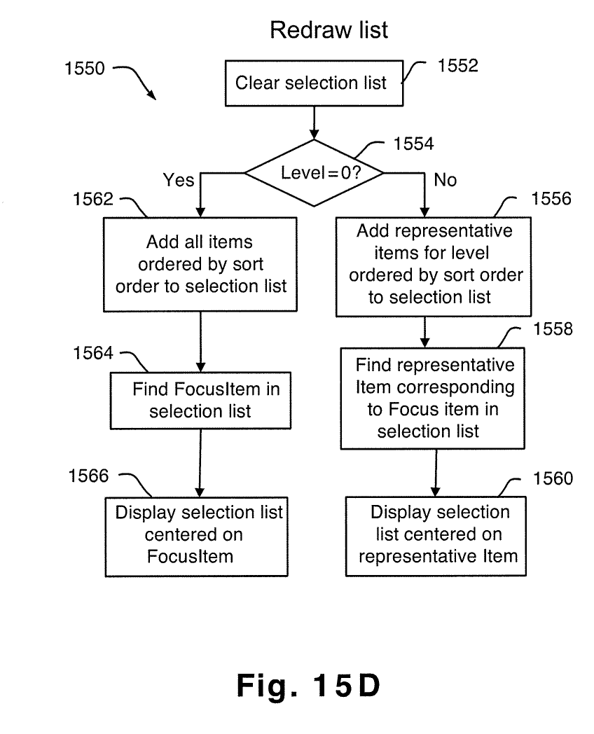

The application program used to implement the browsing methods described above may be summarised by the flowcharts of FIGS. 15A to 15D which each show a sub-routine function performed in a substantially generic implementation. In these flowcharts, essentially three variables are monitored, those being the focus item, the current level and the sort order.

A basic function required in any implementation of browser is to redraw the list of items of the collection, this being seen as a method 1550 in FIG. 15D. Redrawing of the list occurs on commencement of the browser, upon changing level or sort order, and upon changing the grouping level. The method 1550 commences with step 1552 which clears a selection list. Step 1554 then checks the current level to determine if it is the base level (level 0). If it is, step 1562 then adds all items in the collection to the selection list sorted according to the established sort order. Then, step 1564 identifies the focus item in the selection list. This is followed by step 1566 which displays the selection list centred upon the focus item. This display desirably involves placing the focus item at a set display location and may involve displaying only a portion of all items in the selection list.

Where the level is not the base level, step 1556 adds representative items for the current level to the selection list and orders the selection list according to the sort order. The identification of representative items is discussed above and may be performed in a number of ways. Step 1558 follows which finds a representative item corresponding to the focus item in the selection list. Step 1560 then displays the selection list centred upon the representative item found in step 1558.

FIG. 15A shows a method 1510 for stepping the list, this being essentially a scrolling function through the selection list. Step 1512 initially checks the current level. If at the base level, step 1520 steps by a single item in the selection list according to the direction of step, for example as set by the buttons 603, 604 on the controller 105. Step 1522 then sets the focus item to be the item that has been stepped to, and step 1524 then displays the selection list again centred on the focus item.

If not at the base level in step 1512, step 1514 then steps to the next representative item in the selection list. Step 1516 then finds a new focus item corresponding to the new representative item. Step 1518 then follows to display the selection list centred upon the new representative item.

FIG. 15B is a flowchart of a method 1530 for changing the grouping level. Step 1532 takes the current level and determines a new value of current level based upon, for example, which of the buttons 601 or 602 has been pressed, and also the current sort order. Step 1534 then follows to redraw the list, this being by the method 1550 of FIG. 15D.

FIG. 15C shows a method 1540 for changing the sort order. Step 1542 firstly determines a new value of current level based upon the present current level, the current sort order and the new sort order. Step 1544 then sets the current sort order to be the new sort order, and step 1546 then redraws the selection list according to the method 1550.

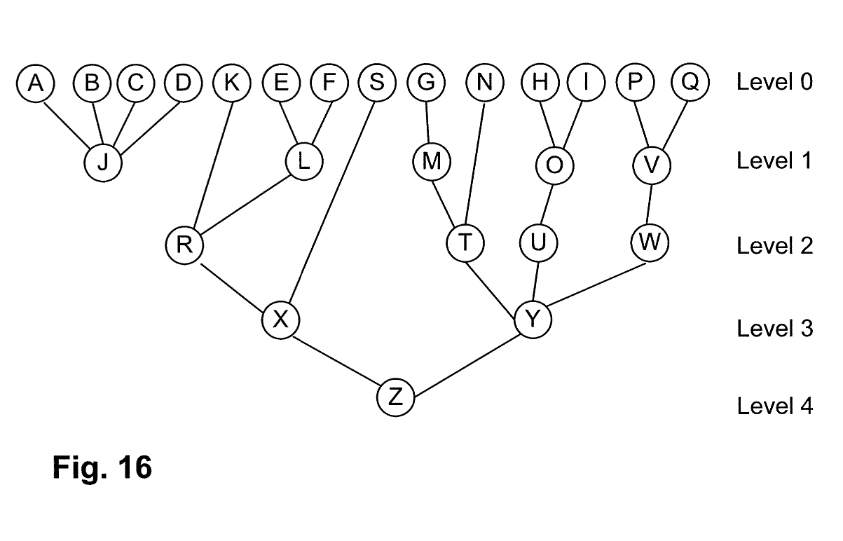

A significant advantage afforded by the above described arrangements is that, for structured collections of items, non-traditional forms of traversal may be used. FIG. 16 shows a hierarchical tree representation of a number of items formed by leaf nodes A, B, C, D, K, E, F, S, G, N, H, I, P, and Q. In this example, five levels are shown where all of the leaf node items reside at level 0, but not all (eg. K, S, and N) items link progressively through each level to the root node Z. The items K, S and N in this example may represent items having metadata that is not as detailed as others, and thus are not able to fully categorised or sorted according to each grouping that may be available. For example, if level 1 is date, level 0 may be time.

In a traditional traversal of the tree of FIG. 16, as used by known browsers, if the item (eg. a photograph) of node A were displayed and the user wished to display the photo at node H, it would be necessary for the user to traverse back through the tree from node A to nodes J, R, X to Z, and then on through nodes Y, U, O and finally to H. There is only one path. Here traversal occurs only via adjacent connected nodes of the tree along the branches.

However with the described arrangements, by which items are sorted within groups and sort order, and groups are selectable, a number of paths are available, including the traditional path. Some additional paths, for the same example are:
(i) A, B, C, D, K, E, F, S, G, N, H (ie. scrolling along all items);
(ii) A, J, L, M, O, H;
(iii) A, J, R, T, U, O, H; and
(iv) A, R, X, Y, W, V, P, I, H.

Numerous other paths can be used. Note that the length of the path is irrelevant. What is significant is the ability to traverse between levels (ie. traversing from one node at one level to an adjacent node at an adjacent said level. For example, S→G, L→M, etc.) and along or across levels (ie. traversing directly from one node at one level to another adjacent node at the same level. For example B→C, N→G, etc.). This browsing process is characterised by traversal in a linear sorted fashion within the current level, or transiting to a higher or lower adjacent level, effectively affording the user freedom of movement within a structured hierarchy.

As noted above, it is desirable to provide for metadata based browsing which maintains the context of browsing operations. This allows the user to navigate a continuous path through the collection of items based on a range of metadata dimensions. The described arrangements facilitate this desire by offering a number of specific advantages, such as:

(1) all data items are presented in a single list;

(2) the list can be re-sorted by attribute values, with the current item retaining focus;

(3) the data items are automatically grouped into multiple hierarchies;

(4) when moving up or down a hierarchy, the same base item remains selected;

(5) an alternate hierarchy can be selected at any level by selecting a re-sort, and the selected base item remains the same;

(6) when choosing another group item, a new base item is automatically chosen; and

(7) the list allows traversing across “folders” or records at any given level with the folder or records being indicated by highlighting, for example.

It will be evident to those skilled in the art that many adaptations are possible to this method of controlling and browsing a list without substantially changing the spirit thereof. For example filters may be included which limit the items shown in the list. Also, the indication of a selected item may be made temporary and only brought into use for certain moments during operation, such as prior to re-ordering or when the user wishes to operate some function on an item. None of these changes are substantial alterations to the nature of the methods described.

The arrangements described herein with reference to FIGS. 1 to 16 operate differently from and afford enhanced functionality over prior art arrangements. For example, in Windows™ Explorer™ as discussed above, items are divided into sets or sub-sets based on the selected sort criteria. However, once the sets are established, the order within each set is arbitrary and not intuitively linked to the selected sort criteria. Such does not create a hierarchy, as there is no association between individual levels of the sort, which affords the intuitive link. In contrast, the present disclosure provides a ‘sort order’ which establishes levels for each sort criteria, such that the levels of one hierarchy are associable with the levels of another hierarchy. This permits, according to the present disclosure, the traversal between hierarchies. Another way of contrasting Windows™ Explorer™ with the present disclosure is that in Windows™ Explorer™ the application creates the displayable structure and then sorts the elements into the established structure. By contrast, in the present disclosure, the sort order is selected and the hierarchical arrangement of items arises from the sort order.

### INDUSTRIAL APPLICABILITY

The arrangements described are applicable to the computer and data processing industries and particularly for the searching or browsing of data from a linear collection of such data. The arrangements find particular application in consumer devices, especially portable media reproduction devices including MP3 players, digital cameras, DVD players and the like.

The foregoing describes only some embodiments of the present invention, and modifications and/or changes can be made thereto without departing from the scope and spirit of the invention, the embodiments being illustrative and not restrictive.

We claim:

1. A method of browsing a collection of sortable items stored in a digital system, said method comprising the steps of:
providing a plurality of grouping hierarchies, each said grouping hierarchy comprising a sort order and zero or more grouping levels forming groups with which said items are associable, wherein at least one said grouping hierarchy comprises a sort order and at least one grouping level;
setting one item in the collection to be a focus item thereby establishing a current focus group of a current grouping hierarchy; and
maintaining the focus item upon selection of a new grouping hierarchy from one of the plurality.

2. A method according to claim 1 further comprising the step of:
displaying a representation of at least part of the collection incorporating at least the new grouping hierarchy associated with the focus item.

3. A method according to claim 1 further comprising maintaining the focus item when changing between one said grouping level and another grouping level within a corresponding grouping hierarchy.

4. A method according to claim 1 wherein grouping levels of respective grouping hierarchies are associated with one another according to an ordinal mapping scheme.

5. A method according to claim 1 wherein grouping levels of respective grouping hierarchies are associated with one another according to a magnitude mapping scheme.

6. A method according to claim 1 wherein grouping levels of respective grouping hierarchies are associated with one another according to an aliased mapping scheme.

7. A method according to claim 1 wherein grouping levels of respective grouping hierarchies are associated with one another according to a combination of mapping schemes at least selected from the group consisting of an ordinal mapping scheme, a magnitude mapping scheme and an aliased mapping scheme.

8. A method according to claim 3, further comprising maintaining a display position of the focus position when selecting a different grouping hierarchy or changing the grouping level.

9. A method according to claim 3 further comprising maintaining a display position of the focus group when selecting a different grouping hierarchy or changing the grouping level.

10. A method according to claim 1 further comprising selecting an item of at least one said group to be a representative item of said one group.

11. A method according to claim 2 further comprising displaying items of the collection in a stack configuration on a display screen.

12. A method according to claim 2 wherein the items are displayed in a list configuration.

13. A method according to claim 1 wherein multiple grouping levels are represented simultaneously.

14. A graphical menu for display via a computerised display comprising a vertically arranged ring and a horizontally arranged ring, where:
each of the rings comprises a plurality of selectable menu items,
one menu item in each said ring is selected at any one time,
the selected menu items are visually dominant in the respective rings, and
the horizontal ring is represented in a plane that is offset from a centre axis of the vertical ring such that the selected menu item of the vertical ring is not obscured by the horizontal ring.

15. A graphical menu according to claim 14 wherein the horizontal ring is located in a plane that is offset from the centre axis of the vertical ring such that the selected menu item and at least one menu item above and one menu item below the selected menu item on the vertical ring are not obscured by the horizontal ring.

16. A graphical menu according to claim 14 where the menu items shown on the horizontal ring are dependent on the selected menu item on the vertical ring.

17. A graphical menu according to claim 14 where the menu items shown on the vertical ring are dependent on the selected menu item on the horizontal ring.

18. A graphical menu according to claim 14 wherein the menu items comprise for each said ring, grouping hierarchies and sort orders relating to a sortable collection of data items accessible via said menu.

19. A method of displaying a collection of items stored in a digital system, said method comprising the steps of:
(a) arranging the items in a list sorted according to one sort order of a plurality of sort orders associable with the items;
(b) providing a plurality of grouping hierarchies, each said grouping hierarchy corresponding to one of the sort orders, wherein each level of each said grouping hierarchy is associable with at least one level of each other said grouping hierarchy; and
(c) displaying at least part of the collection based upon the one sort order of items represented and the corresponding one grouping hierarchy.

20. A method according to claim 19 wherein said displaying comprises displaying at least an identifier of said sort order and displaying an identifier of at least one corresponding said group.

21. A method according to claim 19 further comprising the steps of:
(d) identifying one said item as a focus item within said list;
(e) detecting selection of a different grouping hierarchy; and
(f) repeating step (c) such that the focus item is maintained.

22. A method according to claim 21 wherein step (c) comprises displaying the focus item at a display position, such that during steps (e) and (f), the display position of the focus item is maintained.

23. A method according to claim 22 wherein a grouping hierarchy in which the focus item resides is the focus group, such that during steps (e) and (f), the display position of the focus group is maintained.

24. A method according to claim 22 further comprising:
(g) detecting selection of a different sort order of the plurality and reordering the items in the list according to the different sort order, whereupon a different grouping hierarchy is identified, said different grouping hierarchy and said different sort order corresponding to each other.

25. A method according to claim 22 further comprising traversing the collection such that an item associated at the display position is identified as the focus item.

26. A method according to claim 22 wherein the selection of a different grouping hierarchy at step (e) occurs during the traversal.

27. A method of traversing a hierarchical representation of data, said representation comprising a plurality of data items arranged as a sorted list and a plurality of data attributes associable with each of said items, said representation having intermediate nodes corresponding to said attributes and leaf nodes corresponding to said items, each of the intermediate nodes being associable with a grouping level in the hierarchy, said method comprising the step of:
traversing directly from one said node at one level to another adjacent node at said one level.

28. A method according to claim 27 further comprising traversing from one said node at one said level to an adjacent node at an adjacent said level.

29. A displayable user interface for browsing a collection of data items, said interface comprising:
a first display area in which a list associated with said items is displayable;
a second display area for displaying at least attributes of a focus one said data items;
at least one third display area for displaying selectable sort orders related to said attributes of said data items and groupings related to said sort orders; and
a user operable selection arrangement by which one of the sort orders or the groups is selectable to alter at least a representation of said list in said first display area.

30. An interface according to claim 29 further comprising a tracking arrangement for maintaining a track of said focus data item during traversal of said sort orders and groups until another focus data item is identified.

31. An interface according to claim 30 wherein said first display area has a specified display location such that a data item associated with said display location is said focus data item.

32. An interface according to claim 31 wherein said selection arrangement comprises a scrolling arrangement for scrolling said list through said specified display location.

33. A computer readable medium having a computer program recorded thereon and executable to display a browsing of a collection of data items, said program comprising code for implementing the method of claim 1.

34. Apparatus comprising a display, a store of data items and a computer readable medium according to claim 33 by which said data items can be browsed for selection.
